(19) United States
(12) Patent Application Publication
(10) Pub. No.: US 2019/0376625 A1
(43) Pub. Date: Dec. 12, 2019

(54) ATTACHMENT DEVICE FOR A NON-STRUCTURAL COMPONENT OF A BUILDING

(71) Applicant: Eaton Intelligent Power Limited, Dublin (IE)

(72) Inventors: Alexander William Schickling, Edwardsville, IL (US); Amelia Grattan, San Diego, CA (US); Gregory Jeckstadt, Highland, IL (US); Bret Eilerman, Highland, IL (US); Zac J. Brown, St. Louis, MO (US); Michael Tosunian, Brea, CA (US)

(21) Appl. No.: 16/433,552

(22) Filed: Jun. 6, 2019

Related U.S. Application Data
(60) Provisional application No. 62/682,313, filed on Jun. 8, 2018.

(51) Int. Cl. F16L 3/127

(52) U.S. Cl. CPC F16L 3/127; F16L 3/015

(57) ABSTRACT

An attachment device for securing a non-structural component of a building to a structural component of the building includes an attachment device member configured to be attached to the non-structural component and to partially surround the non-structural component. A fastening component forms a connection between the non-structural component and the attachment device member. The connection does not compress the non-structural component and inhibits movement of the non-structural component relative to the attachment device member. An attachment component is coupled to the attachment device member and attaches to the structural component for securing the non-structural component to the structural component via the attachment device member.

### CROSS-REFERENCE TO RELATED APPLICATION

This application claims the benefit of U.S. Provisional Application No. 62/682,313, filed Jun. 8, 2018, the entirety of which is hereby incorporated by reference.

### FIELD OF THE DISCLOSURE

The present disclosure generally relates to attachment devices for coupling a non-structural component to a structural component of a building.

### BACKGROUND OF THE DISCLOSURE

Sway braces and restraints are used to secure non-structural components to a building and minimize the differential movement between the non-structural components and the building itself. Examples of non-structural components in a building include, but are not limited to, pipes, conduits, round ducts, fittings, etc. Sway brace or restraint assemblies generally include an attachment device (e.g., pipe attachment device) that attaches to the pipe and couples a sway brace or restraint to the pipe. One conventional attachment device includes a clamp (e.g., pipe clamp) that attaches to the non-structural component (e.g., pipe) and to the sway brace, restraint or other bracing member. The sway brace or restraint is then attached to a structural element of the building (e.g., a beam), thereby securing the non-structural component to the building.

### SUMMARY OF THE DISCLOSURE

In one aspect, an attachment device for connecting a non-structural component to a structural component of a building (e.g., a beam, a brace, a restraint, etc.) is configured to inhibit over-compressing or over-clamping of the non-structural component.

In another aspect, an attachment device for securing a non-structural component of a building to a structural component of the building comprises an attachment device member configured to be attached to the non-structural component and to partially surround the non-structural component. A fastening component is configured to form a connection between the non-structural component and the attachment device member. The connection does not compress the non-structural component and inhibits movement of the non-structural component relative to the attachment device member. An attachment component is coupled to the attachment device member and is configured to attach to the structural component for securing the non-structural component to the structural component via the attachment device member.

In another aspect, an attachment device for securing a non-structural component of a building to a structural component of the building comprises first and second attachment device members configured to be coupled to one another to attach the first and second attachment device members to the non-structural component. The first and second attachment device members are sized and shaped to completely surround the non-structural component. The first and second attachment device members are configured to not deform the non-structural component and inhibit the movement of the non-structural component relative to the first and second attachment device members when the first and second attachment device members are attached to the non-structural component. At least one fastening component is configured to couple the first and second attachment device members together. At least one attachment component is attached to at least one of the first and second attachment device members and is configured to attach to the structural component for securing the non-structural component to the structural component via the first and second attachment device members. Other objects and features will be in part apparent and in part pointed out hereinafter.

### BRIEF DESCRIPTION OF THE DRAWINGS

FIG. 1 is a perspective of one example of a sway brace/restraint that can be used with attachment devices of the present disclosure;

FIG. 2 is a perspective of a first embodiment of an attachment device coupling a non-structural component to a structural component according to the teachings of the present disclosure;

FIG. 3 is top perspective of the attachment device of FIG. 2;

FIG. 4 is a bottom perspective thereof;

FIG. 5 is a perspective of a second embodiment of an attachment device coupled to a non-structural component according to the teachings of the present disclosure;

FIG. 6 is a top perspective of a third embodiment of an attachment device for coupling a non-structural component to a structural component according to the teachings of the present disclosure;

FIG. 7 is a bottom perspective of the attachment device of FIG. 6;

FIG. 8 is a perspective of a fourth embodiment of an attachment device for coupling a non-structural component to a structural component according to the teachings of the present disclosure;

FIG. 9 is an exploded view of first and second attachment device members of the attachment device of FIG. 8;

FIG. 10 is a perspective of a fifth embodiment of an attachment device for coupling a non-structural component to a structural component according to the teachings of the present disclosure;

FIG. 11 is an exploded view of the attachment device of FIG. 10;

FIG. 12 is a perspective of a sixth embodiment of an attachment device coupled to a non-structural component according to the teachings of the present disclosure;

FIG. 13 is an exploded view of the attachment device of FIG. 12;

FIG. 14 is a perspective of a seventh embodiment of an attachment device coupled to a non-structural component according to the teachings of the present disclosure;

FIG. 15 is a front perspective of a first attachment device member of the attachment device of FIG. 14;

FIG. 16 is a rear perspective of the first attachment device member of FIG. 15;

FIG. 17 is a perspective of a second attachment device member of the attachment device of FIG. 14;

FIG. 18 is a perspective of an eighth embodiment of an attachment device coupling a non-structural component to a structural component of a building according to the teachings of the present disclosure;

FIG. 19 is a perspective of the attachment device of FIG. 18;

FIG. 20 is a perspective of a ninth embodiment of an attachment device coupled to a non-structural component according to the teachings of the present disclosure;

FIG. 21 is an exploded view of the attachment device of FIG. 21;

FIG. 22 is a perspective of a tenth embodiment of an attachment device for coupling a non-structural component to a structural component according to the teachings of the present disclosure;

FIG. 23 is an exploded view of the attachment device of FIG. 22;

FIG. 24 is a front view of first and second attachment device members of the attachment device of FIG. 22;

FIG. 25 is a perspective of an eleventh embodiment of an attachment device coupled to a non-structural component according to the teachings of the present disclosure;

FIG. 26 is a front perspective of the attachment device of FIG. 25;

FIG. 27 is a rear perspective of the attachment device of FIG. 25;

FIG. 28 is a section of the attachment device taken through line 28-28 of FIG. 26;

FIG. 29 is a perspective of a twelfth embodiment of an attachment device for coupling a non-structural component to a structural component according to the teachings of the present disclosure; and

FIG. 30 is a perspective of a variation of the attachment device of FIG. 29. Corresponding reference characters indicate corresponding parts throughout the drawings.

### DETAILED DESCRIPTION OF THE DISCLOSURE

Overall, the attachment devices of the various embodiments described herein are for coupling a non-structural component to a structural component via a sway brace or restraint. Broadly, the attachment device and the sway brace/restraint may be considered a sway brace/restraint assembly. The attachment devices can be secured to any suitable restraint or sway brace, such as a longitudinal or lateral sway brace/restraint, or can be secured to any structural element of a building such as a beam, floor, ceiling, for example. The term structural component includes, but is not limited to, a sway brace, a restraint, and building structural elements, such as beams, floors, joists, columns, ceilings, etc. The various attachment devices are each configured to inhibit over-compressing or over-clamping on the particular non-structural component that is to be supported (e.g., braced or restrained) in a building. In this way, the attachment device is configured to inhibit structural damage to the non-structural component due to over-compression or over-clamping. For example, the various attachment devices of the present disclosure allow builders (e.g., construction workers, contractors, etc.) to brace or restrain metal pipes, soft metal pipes (e.g., brass, copper, etc.), plastics and other non-structural components that cannot withstand compressive loads typically applied by conventional sway brace/restraint assemblies. In addition, by coupling to the non-structural component at a specific location and/or in a specific manner, the various attachment devices disclosed herein can prevent the non-structural component from moving longitudinally. Thus, the attachment devices of the present disclosure are able to be secured to a non-structural component in such a manner that prevents over-compression but inhibits movement (e.g., longitudinal, lateral, and/or rotational movement) of the non-structural component.

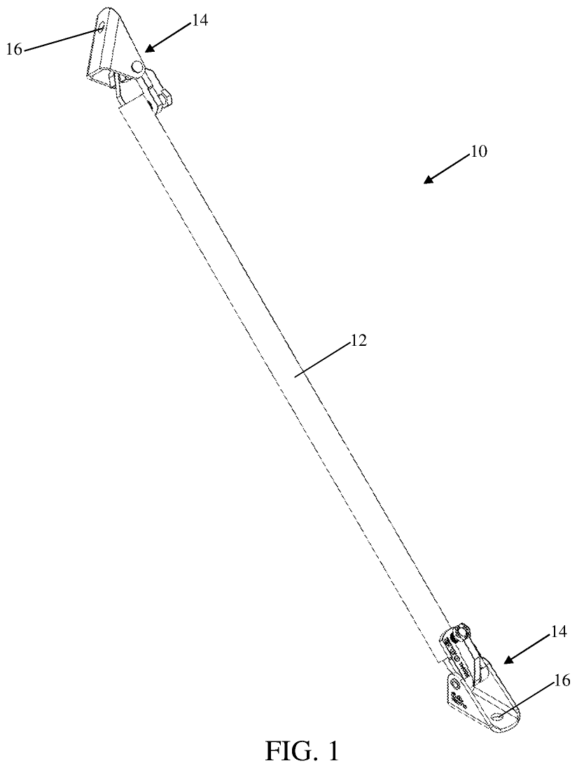

Referring to FIG. 1, one example of a suitable sway brace or restraint that can be used with the various attachment devices described below is generally indicated at reference numeral 10. As generally known in the art, the sway brace/restraint 10 includes a strut 12 (e.g., pipe, bar, rod, etc.) and opposite connection fittings 14 at each end of the strut. One connection fitting 14 may be used to attach the sway brace/restraint 10 to a structure (e.g., a beam of a building) and the opposite connection fitting 14 can be used to attach the sway brace/restraint to one or more of the various attachment devices described below. When the attachment device is coupled to the non-structural component, the sway brace/restraint spans between the non-structural component and the building, thereby supporting the non-structural component in the building. In the illustrated embodiment, each of the connection fittings 14 are identical and define a fastener opening 16 that can be used to connect the connection fitting to any one of the various attachment devices, as described in more detail below. Further details of sway braces and restraints may be found in U.S. Pat. No. 6,273,372, hereby incorporated by reference in its entirety. It is understood that the sway brace/restraint 10 in FIG. 1 is illustrative and that the various attachment devices of the present disclosure may be used with any suitable sway brace/restraint. For example, the sway brace/restraint may be a seismic sway brace/restraint. Furthermore, it is contemplated that any one of the various attachment devices described below may be directly connected to the strut 12 of the sway brace/restraint 10 (e.g., replace one of the connection fittings 14 at one end of the strut 12), as is generally known in the art.

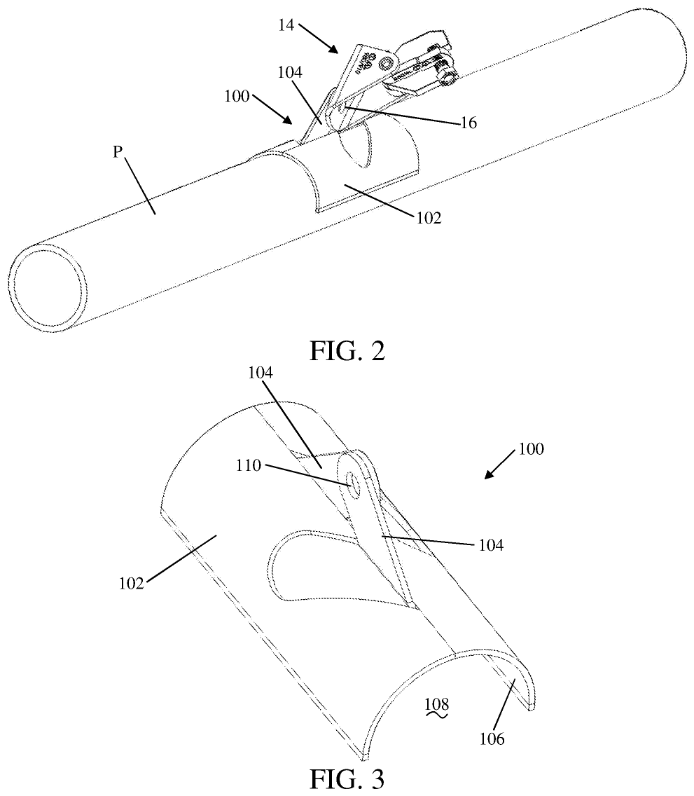

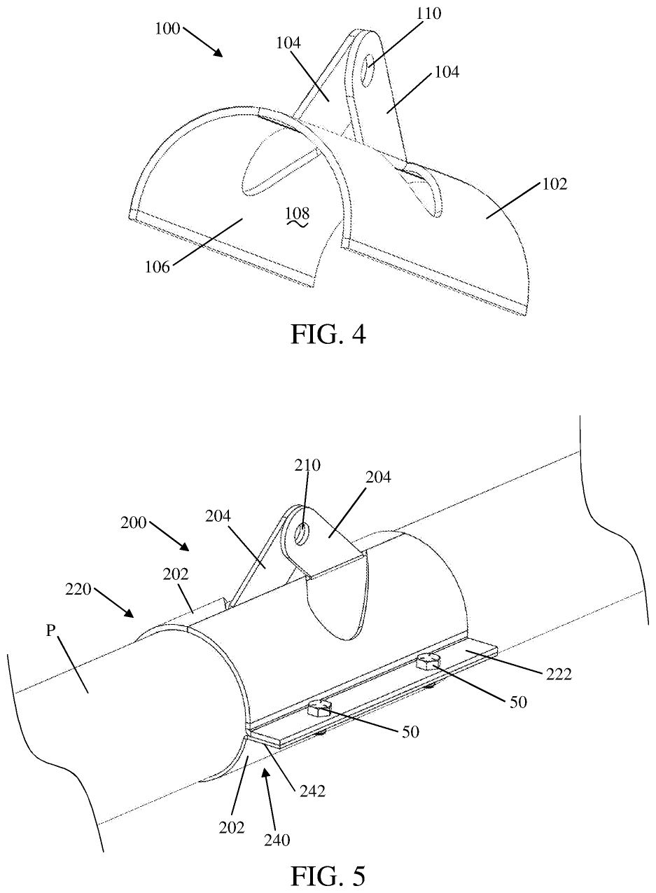

Referring to FIGS. 2-4, a first embodiment of an attachment device for coupling a non-structural component to a structural component, such as the sway brace/restraint 10, is generally indicated at reference numeral 100. As shown in FIG. 2, attachment device 100 is configured to be attached to the non-structural component, such as a pipe P, and to the connection fitting 14 of the sway brace/restraint 10. The attachment device 100 includes a body or arcuate portion 102 (broadly, an attachment device member) configured to be coupled to the pipe P and at least one connection tab 104 secured to the body portion and configured to be attached to the sway brace/restraint 10. The body portion 102 is configured to circumferentially extend around at least a portion of the pipe P and has an interior surface 106 that defines a receiving space 108 sized and shaped to receive the pipe P. The interior surface 106 is sized and shaped to correspond to the size and shape of the exterior of the pipe P such that when the pipe is received in the receiving space 108, the interior surface of the body portion 102 engages the exterior surface of the pipe. In the illustrated embodiment, the interior surface 106 is concave and curved to correspond to the curved exterior surface of the pipe P. The attachment device 100 includes an adhesive (not shown) spread out over the interior surface 106 of the body portion 102. As described in more detail below, the adhesive (broadly, a fastening component) is used to permanently attach the attachment device 100 to the pipe P. In the preferred embodiment, the body portion 102 (more specifically, the interior surface 106) is generally semi-cylindrical in shape such that the body portion circumferentially extends only partly around the pipe P. In the illustrated embodiment, the body portion 102 extends approximately halfway around the pipe P and has a length extending between opposite ends of the body portion (e.g., generally parallel to the longitudinal axis of the pipe P) that is, preferably, at least two times greater than a diameter of the pipe and an effective diameter of the body portion 102. These dimensions provide the interior surface 106 with a large surface area so that a sufficient amount of adhesive can be applied thereon to permanently attach the attachment device 100 to the pipe P.

In the illustrated embodiment, the attachment device 100 includes two connection tabs 104. In other embodiments, the attachment device 100 only includes one connection tab 104 or more than two connections tabs. The illustrated connection tabs 104 generally extend radially outward and toward one another from the center of the body portion 102. In this manner, the connection tabs 104 extend outward at an angle relative to a longitudinal axis defined by the generally semi-cylindrical shaped body portion 102. In other embodiments, the connection tabs 104 may extend outward at other angles relative to the longitudinal axis. For example, the connection tabs 104 may extend outward at an angle that is generally perpendicular to the longitudinal axis of the body portion. Each connection tab 104 is connected to the body portion 102 at one end (e.g., base) and defines a fastener opening 110 at the opposite end (e.g., free end). The free end of the connection tab 104 is spaced from the body portion 102 such that the fastener opening 110 is positioned away from the body portion. In the illustrated embodiment, both connection tabs extend, at an angle, from the body portion 102 such that the free ends of the connection tabs 104 overlap with each other so that the fastener openings 110 of the connection tabs are aligned. As shown in FIG. 3, the two connection tabs 104 extend on either side of a generally vertical plane extending through the attachment device 100. The connection tabs 104 are arranged with respect to the body portion 102 such that aligned fastener openings 110 are approximately positioned above the longitudinal midpoint of the body portion 102. As shown in FIG. 2, a single fastener (not shown), such as a bolt, can be inserted though the aligned fastener openings 110 of the connection tabs 104 to attach the attachment device 100 to the connection fitting 14 of the sway brace/restraint 10. Each connection tab 104 is, broadly, an attachment component for attaching the attachment device to the structural component. In other embodiments, the fastener openings 110 are not aligned and the connection tabs 104 do not overlap each other such that each connection tab can be attached to a separate sway brace/restraint. For example, in one embodiment, the one or more connection tabs 104 extend outward from different sides of or different locations on the body portion 102 (e.g., different lines extending between opposite ends of the body portion) so that the attachment device 100 can be attached to multiple sway braces/restraints. In one embodiment, the tabs 104 can be positioned to affect both lateral and longitudinal bracing. Further, it is understood that the one or more connection tabs 104 can have other arrangements than described herein.

In one embodiment, the attachment device 100 is formed from a single piece of material, such as a metal blank that is stamped from a piece of sheet metal and bent into shape. For example, in the illustrated embodiment, the connection tabs 104 are originally sections of the body portion 102 that are cut on three sides and bent to the shape shown, leaving openings in the body portion. In one embodiment, the attachment device 100 is stamped from a 12-14 gauge piece of sheet metal, although other gauges are within the scope of the present disclosure. However, it is understood that any suitable material(s) may be used to construct the attachment device 100. For example, the attachment device 100 can also be formed from plastic.

To attach the attachment device 100 to pipe P, the attachment device and pipe are brought together such that the pipe moves into the receiving space 108 and is pressed against the adhesive so that the adhesive can bond to the pipe. In this position, the interior surface 106 of the body portion 102 is engaged with the exterior surface of the pipe P such that the adhesive covering the interior surface contacts and bonds to the exterior surface of the pipe P. Preferably, the adhesive is of a type that adheres strongly on contact with the non-structural component (e.g., pipe P) and can adhere to a wide variety of different materials, such as metal, plastic or any other material of the non-structural component. In one embodiment, the adhesive is covered with a protective release strip (not shown), such as a portion of plastic film or other material that does not permanently bond with the adhesive, to prevent the adhesive from bonding to another surface prematurely and is configured to be peeled away to expose the adhesive when the attachment device 100 is ready to be attached to the pipe P. In another embodiment, the adhesive is a separate element that is spread out over the interior surface 106 of the body portion 102 immediately before the attachment device 100 is attached to the pipe P. The adhesive can be a film adhesive, mixed adhesive or any other suitable adhesive. In the illustrated embodiment, the attachment device 100 is attached to the top of the pipe P, however, it is understood that the attachment device can be attached to the pipe at other locations (e.g., bottom or side). Once the adhesive bonds to the non-structural component, the attachment device 100 is attached to the non-structural component in a manner (e.g., bonded with adhesive) that does not compress (e.g., deform) the non-structural component while inhibiting movement of the non-structural component (relative to the attachment device).

As used throughout this disclosure, a pipe P is the non-structural component used to facilitate the description of the various embodiments of the attachment devices disclosed herein. It is understood that the attachment devices disclosed herein may be attached to any non-structural component, not just pipes P. Moreover, it is also understood that the attachment devices disclosed herein may be sized and shaped to attach to non-structural components with other exterior shapes (e.g., square, rectangle, I-beam, etc.) than described herein (e.g., a cylinder-shaped pipe). Moreover, in one or more embodiments, the pipe P is formed from a material other than steel. For example, the pipe P may comprise plastic, such as a thermoplastic material, including but not limited to polyvinyl chloride (PVC), such as chlorinated polyvinyl chloride (CPVC). In another example, the pipe P may comprise copper or other metals that are softer than steel.

Referring to FIG. 5, a second embodiment of an attachment device for coupling a non-structural component to a structural component, such as the sway brace/restraint 10, is generally indicated at reference numeral 200. As shown in FIG. 5, attachment device 200 is configured to be attached to the non-structural component, such as a pipe P, and a structural component. The attachment device 200 includes a first attachment device member 220 and a second attachment device member 240. The first and second attachment device members 220, 240 are configured to be connected to one another such that they surround (e.g., circumferentially extend around) the pipe P. The first attachment device member 220 is similar, in both form and operation, to attachment device 100, described above. Thus, for ease of comprehension, where analogous parts are used, reference numerals “100” units higher are employed. In addition to the components described above in relation to attachment device 100, the first attachment device member 220 of attachment device 200 further includes generally planar opposite first and second connection flanges 222, respectively, extending radially outward from the opposite side edge margins of the body portion 202 (it is appreciated that the second connection flange is on the opposite side of the pipe P in FIG. 5 and, thus, hidden from view). Each connection flange 222 of the first attachment device member 220 is configured to attach to corresponding first and second connection flanges 242, respectively, of the second attachment device member 240, thereby attaching the first and second attachment device members together. In one embodiment, the second attachment device member 240 may be identical to the first attachment device member 220 (and, thus, similar in form and function to attachment device 100). In another embodiment, the second attachment device member 240 is identical to the first attachment device member 220 except that the second attachment device member does not include connection tabs.

As shown in FIG. 5, when the first and second attachment device members 220, 240 are attached together, they define the receiving space sized and shaped to receive the non-structural component, pipe P. Specifically, the interior surfaces (not shown) of the body portions 202 of the first and second attachment device members 220, 240 define the receiving space. In this manner, the first and second attachment device members 220, 240 form a cylinder that circumferentially extends around the pipe P. The illustrated connection flanges 222, 242 of the first and second attachment device members 220, 240 each define at least one fastener opening that receives a fastener 50 (e.g., fastener assembly—bolt, nut, washers) to connect the first and second attachment device members together. Each fastener opening in the first attachment device member 220 is aligned with a corresponding fastener opening in the second attachment device member 240, such that a single fastener 50 (broadly, a fastening component) can be inserted there through. It is understood that other ways of attaching the first and second attachment device members 220, 240 to one another, such as with adhesive, tape, and/or clamps, are within the scope of the present disclosure. In one embodiment, connection flanges 222, 242 include additional structure, such as additional fastener openings, such that a structural component can be attached to the attachment device 200 via the connection flanges. In this embodiment, the attachment device 200 may or may not include connection tabs 204. Fastener openings may also be formed in the flanges 222, 242 through the connection of the structural component to the flanges.

The receiving space is, preferably, oversized (e.g., slightly larger) than the non-structural component such that the attachment device 200 applies little to no clamping force to the non-structural component. In the illustrated embodiment, this means the receiving space has a diameter that is larger (e.g., slightly larger) than the exterior diameter of the pipe P. Should the attachment device 200 apply any clamping force to the non-structural component, the large surface areas of the interior surfaces of the first and second attachment device members 220, 240 sufficiently spread out the clamping force over a portion of the non-structural component to prevent the non-structural component from deforming. In one embodiment the attachment device 200 include an adhesive (broadly, a fastening component), as described above, that covers one or both of the interior surfaces of the first and second attachment device members 220, 240 and bonds to the non-structural component, pipe P, to permanently attach the attachment device to the pipe. In this embodiment, the connection of the first and second attachment device members 220, 240 together, with the connection flanges 222, 242 are, preferably, utilized to hold the first and second attachment device members on the non-structural component to allow the adhesive to cure and bond to the pipe P. In another embodiment, the attachment device 200 does not include adhesive, but, instead, includes a compressible member (not shown) that is inserted between the non-structural component (e.g., pipe P) and the first and second attachment device members 220, 240. The compressible member is compressible and is configured to compress and deform such that any clamping force applied by the attachment device 200 deforms the compressible member, not the non-structural component (e.g., the compressible member is substantially easier to compress and deform than the non-structural component). Moreover, the deformation of the compressible member spreads any clamping force applied by the attachment device 200 to the non-structural component over a large portion of the non-structural component to prevent the non-structural component from deforming. The engagement between the compressible member and the non-structural component allows the attachment device 200 to grip the non-structural component, preventing any movement there between. The compressible member can be a separate component that is inserted in between the attachment device 200 and the non-structural component before the attachment device is coupled to the pipe P or the compressible member can be a material or coating applied (e.g., attached) to the interior surfaces of the first and second members 220, 240. The compressible member can be made from any suitable material such as rubber or felt. Thus, the attachment device 200 is configured to be attached to the non-structural component in a manner that does not compress or deform the non-structural component while still inhibiting movement of the non-structural component (relative to the attachment device).

In one embodiment, the first and second attachment device members 220, 240 of the attachment device 200 are each formed from a single piece of material, such as a metal blank that is stamped from a piece of sheet metal and bent into shape. In one embodiment, the attachment device members 220, 240 are stamped from a 12-14 gauge piece of sheet metal, although other gauges are within the scope of the present disclosure. It is understood that any suitable material(s) may be used to construct the attachment device 200.

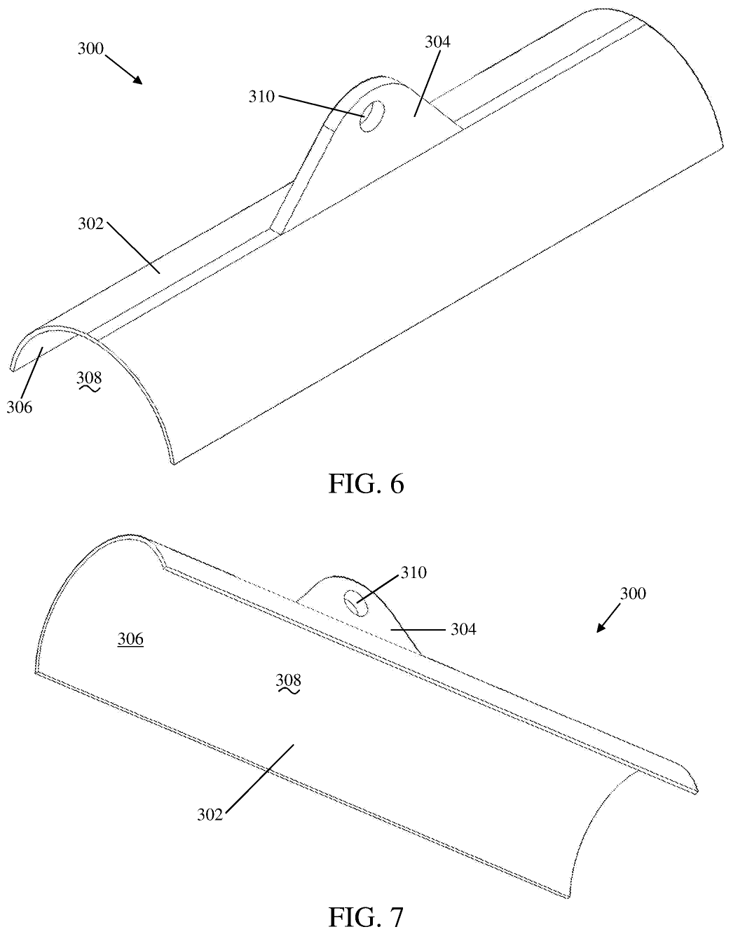

Referring to FIGS. 6 and 7, a third embodiment of an attachment device for coupling a non-structural component to a structural component, such as the sway brace/restraint 10, is generally indicated at reference numeral 300. The attachment device 300 is configured to be attached to the non-structural component, such as a pipe P. The attachment device 300 is similar, in both form and operation, to attachment device 100, described above. Thus, for ease of comprehension, where analogous parts are used, reference numerals “200” units higher are employed (relative to attachment device 100). The attachment device 300 is similar to the attachment device 100 of the first embodiment, described above, except that connection tab 304 has a different configuration than connection tab 104. In this embodiment, connection tab 304 is integrally formed with the body portion 302. The connection tab 304 extends radially outward from the body portion 302, near the center thereof. The connection tab 304 has a generally triangular shape with a base attached to the body portion. The connection tab 304 defines the fastener opening 310 near the top of connection tab (e.g., spaced from the body portion 302) that may receive a fastener (not shown) to connect the attachment device 300 to a structural component. The connection tab 304 is, broadly, an attachment component for attaching the attachment device to the structural component. As described above with respect to attachment device 100, it is understood that attachment device 300 can have one or more connection tabs 304 at different locations and of different configurations on the body portion 302 to connect to one or more sway brace/restraint assemblies.

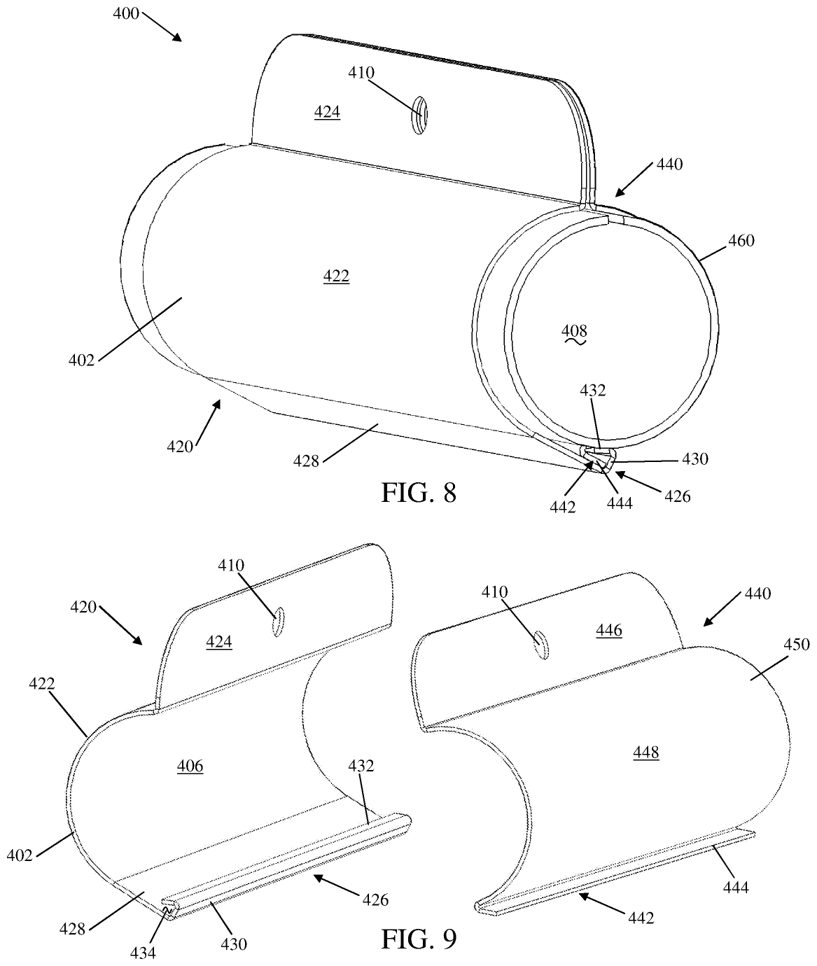

In the illustrated embodiment, the attachment device 300 is formed from a single piece of material, such as plastic that has been injection molded into shape. In another embodiment, the attachment device 300 is formed from a metal blank that is stamped from a piece of sheet metal and bent into shape. The attachment device 300 can be stamped from a 12-14 gauge piece of sheet metal, although other gauges are within the scope of the present disclosure. It is understood that any suitable material(s) may be used to construct the attachment device 300. Otherwise, the attachment device 300 is the same as attachment device 100 and operates in the same way (e.g., the description related to the form and operation of attachment device 100 is applicable to attachment device 300). Thus, the attachment device 300 is configured to be attached to the non-structural component in a manner (e.g., bonded with adhesive) that does not compress (e.g., deform) the non-structural component while still inhibiting movement of the non-structural component (relative to the attachment device). Referring to FIGS. 8 and 9, a fourth embodiment of an attachment device for coupling a non-structural component to a structural component, such as the sway brace/restraint 10, is generally indicated at reference numeral 400. The attachment device 400 is configured to be attached to the non-structural component, such as a pipe P, and to a structural component. The attachment device 400 includes a first attachment device member 420 and a second attachment device member 440. The first and second attachment device members 420, 440 are configured to be connected to one another such that they surround (e.g., circumferentially extend at least partially around) the pipe P. When the first and second attachment device members 420, 440 are connected together, they define a receiving space 408 sized and shaped to receive the non-structural component, such as pipe P, and extend completely around the pipe. As shown in FIG. 8, the attachment device 400 also includes a compressible member 460 configured to be inserted between the first and second attachment device members 420, 440 and the non-structural component, as described in more detail below.

The first attachment device member 420 has a body portion 402 configured to partially circumferentially extend around the non-structural component. The body portion 402 includes a central arcuate portion 422 with opposite edge margins (e.g., ends), a connection flange 424 extending radially outward from one of the edge margins of the central arcuate portion, a catch 426 positioned at the opposite edge margin of the central arcuate portion. As explained in more detail below, the catch 426 is configured to receive and interlock with a hook 442 (broadly, a portion) of the second attachment device member 440 to connect the first and second attachment device members 420, 440 together. Broadly, the catch 426 and hook 442 are each interlocking portions (e.g., male and female interlocking portions or members) that interlock with one another to connect the first and second attachment device members 420, 440 together. The central arcuate portion 422 is configured to circumferentially extend around at least a portion of the pipe P and has an interior surface 406 that partially defines the receiving space 408 sized and shaped to receive the pipe P. The central arcuate portion 422 is curved to correspond to the size and shape of the pipe P such that the interior surface 406 is concave and curved to correspond to the exterior surface of the pipe. In the preferred embodiment, the central arcuate portion 422 (more specifically, the interior surface 406) is generally semi-cylindrical in shape such that the central arcuate portion circumferentially extends nearly or approximately halfway around the pipe P and has a length extending between opposite ends of the central arcuate portion (e.g., generally parallel to a longitudinal axis of the pipe P received in the receiving space 408) that is, preferably, at least two time greater than a diameter of the pipe and an effective diameter of the central arcuate portion. These dimensions provide the interior surface 406 with a large surface area, for reasons explained herein.

The catch 426 is positioned on the first attachment device member 420 opposite the connection flange 424 such than when the first attachment device member is mounted on the non-structural component the connection flange 424 and catch 426 are positioned on generally opposite sides of the non-structural component. The illustrated catch 426 includes a first flange 428 connected to the edge margin of the central arcuate portion 422 and extending therefrom at an angle that is generally tangential to the curve of the central arcuate portion, a second flange 430 extending from an end (e.g., edge margin) of the first flange in a generally upward direction that is generally perpendicular to the first flange, and a third flange 432 extending from an end (e.g., edge margin) of the second flange in a direction that is generally toward the first flange (e.g., the angle between the second and third flanges is acute) to a free end that is spaced apart from the first flange. Together, the second, third, and a portion of the first flanges 430, 432, 428 define a hook receiving space 434 configured to receive the hook 442 of the second attachment device member 440. In the illustrated embodiment, the first, second and third flanges 428, 430, 432 of the catch 426 extend along the entire length of the body portion 402. In another embodiment, the first, second and third flanges 428, 430, 432 of the catch 426 extend along only a portion of the length of the body portion.

The second attachment device member 440 is similar to the first attachment device member 420. The second attachment device member 440 has a body portion 450 configured to partially circumferentially extend around the non-structural component. The body portion 450 includes a central arcuate portion 448 with opposite edge margins (e.g., ends) and a connection flange 446 extending radially outward from one of the edge margins of the central arcuate portion. The central arcuate portion 448 and connection flange 446 are generally analogous to the respective central arcuate portion 422 and connection flange 424 of the first attachment device member 420. However, instead of the catch 426, the second attachment device member 440 includes the hook 442 positioned at the opposite edge margin of the central arcuate portion 448 relative to the connection flange 446. As explained in more detail below, the hook 442 is configured to engage and interlock with the catch 426 of the first attachment device member 420 to connect the first and second attachment device members together. The central arcuate portion 448 is configured to circumferentially extend around at least a portion of the pipe P and has an interior surface (not shown) that partially defines the receiving space 408 sized and shaped to receive the pipe P. The central arcuate portion 448 is curved to correspond to the size and shape of the pipe P such that the interior surface is concave and curved to correspond to the exterior surface of the pipe. In the preferred embodiment, the central arcuate portion 448 of the second attachment device member 440 is of a similar size and shape to the central arcuate portion 422 of the first attachment device member such that the interior surface of the second attachment device member also has a large surface area.

The hook 442 is positioned on the second attachment device member 440 opposite the connection flange 446 such than when the second attachment device member is mounted on the non-structural component the connection flange and hook are positioned on generally opposite sides of the non-structural component. The illustrated hook 442 includes a first flange 444 extending from the end (e.g., edge margin) of the central arcuate portion 448 in a direction that is generally outward and back along a portion of the central arcuate portion (e.g., the angle between the central arcuate portion and first flange is acute) to a free end that is spaced from the central arcuate portion. The first flange 444 of the hook 442 is configured to be received in the hook receiving space 434 of the catch 426. In the illustrated embodiment, the first flange 444 of the hook 442 extends along the entire length of the body portion 450. In another embodiment, the first flange 444 of the hook 442 extends along only a portion of the length of the body portion 450.

The connection flanges 424, 446 of the first and second attachment device members 420, 440 are configured to attach to one another. Each connection flange 424, 446 defines at least one fastener opening 410 that receives a fastener (e.g., fastener assembly—bolt, nut, washers) to connect the first and second attachment device members together 420, 440. When connected together, the fastener opening 410 in the first attachment device member 420 is aligned with a corresponding fastener opening 410 in the second attachment device member 440, such that a single fastener (not shown) can be inserted there through. It is understood that other ways of attaching the first and second attachment device members 420, 440 to one another, such as with adhesive, tape, and/or clamps, are within the scope of the present disclosure.

As shown in FIG. 8, when the first and second attachment device members 420, 440 are attached together, they define the receiving space 408 sized and shaped to receive the non-structural component (e.g., pipe P). Specifically, the interior surfaces 406 of the body portions 402, 450 of the first and second attachment device members 420, 440 define the receiving space 408 (the catch also 426 defines a portion of the receiving space). In this manner, the first and second attachment device members 420, 440 generally form a cylinder that circumferentially extends around the pipe P. To attach the first and second attachment device members 420, 440 together, the hook 442 is interlocked with the catch 426. Specifically, the first flange 444 of the hook 442 is inserted into the hook receiving space 434 of the catch 426. In this position, the hook 442 and catch 426 form a hinge (broadly, a fastening component) between the first and second attachment device members 420, 440, permitting the attachment device members to rotate or pivot about the hinge. It is understood that other ways of pivotally connecting the first and second attachment device members 420, 440 are within the scope of the present disclosure. A shown in FIG. 8, the catch 426 and hook 442 are positioned (e.g., below) such that they do not interfere with the reception of the non-structural component in the central arcuate portions 422, 448. In fact, when the first and second attachment device members 420, 440 are connected together, the first flanges 428, 444 engage and are generally parallel with one another. Once the first and second attachment device members 420, 440 are pivotally connected together (e.g., the hook 442 is mated with the catch 426), the attachment device 400 is positioned over the non-structural component and a fastener (not shown) (broadly, a fastening component) is inserted through the fastener openings 410 to secure the connection flanges 424, 446 together. When the connection flanges 424, 446 are connected together, the engagement of the connection flanges with one another and the engagement, if any, of the central arcuate portions 442, 448 with the non-structural component keeps the hook 444 and catch 426 interlocked. In one embodiment, the fastener extending through connection flanges 424, 446 is also used to connect the attachment device 400 to a structural component. Each connection flange 424,446 is, broadly, an attachment component for attaching the attachment device to the structural component. In another embodiment, connection flanges 424 include additional structure, such as additional fastener openings, so that the attachment device 400 can be attached to a structural component.

The receiving space 408 is, preferably, oversized (e.g., slightly larger) than the non-structural component such that the attachment device 400 applies little to no clamping force to the non-structural component. In the illustrated embodiment, this means the receiving space has a diameter that is larger (e.g., slightly larger) than the exterior diameter of the pipe P. Should the attachment device 400 apply any clamping force to the non-structural component, the large surface areas of the interior surfaces 406 of the first and second attachment device members 420, 440 sufficiently spread out the clamping force over a portion of the non-structural component to prevent the non-structural component from deforming. As shown in FIG. 8, the illustrated attachment device 400 includes the compressible member 460 that is positioned between the non-structural component (e.g., pipe P) and the first and second attachment device members 420, 440. The compressible member 460 is compressible and is configured to compress and deform such that any clamping force applied by the attachment device 400 deforms the compressible member, not the non-structural component (e.g., the compressible member is substantially easier to compress and deform than the non-structural component). Moreover, the deformation of the compressible member spreads any clamping force applied by the attachment device 400 to the non-structural component over a large portion of the non-structural component to prevent the non-structural component from deforming. The engagement between the compressible member 460 and the non-structural component allows the attachment device 400 to grip the non-structural component, preventing any movement there between. The illustrated compressible member 460 is a generally flat sheet of material that is flexible enough to conform to the exterior shape of the non-structural component, in this case a cylinder. The compressible member 460 can be a separate component that is inserted between the attachment device 400 and the non-structural component before the attachment device is coupled to the pipe P or the compressible member can be a material or coating applied to the interior surfaces of the first and second members 420, 440. The compressible member can be made from any suitable material as described above. In one embodiment, the attachment device 400 includes adhesive (broadly, a fastening component) instead of the compressible member 460, as described above, to bond the first and second attachment device members 420, 440 to the non-structural component. In another embodiment, adhesive is applied to the inner surface of the compressible member 460. Thus, the attachment device 400 is configured to be attached to the non-structural component in a manner that does not compress or deform the non-structural component while inhibiting movement of the non-structural component (relative to the attachment device).

In one embodiment, the first and second attachment device members 420, 440 of the attachment device 400 are formed from a single piece of material, such as a metal blank that is stamped from a piece of sheet metal and bent into shape. In one embodiment, the attachment device members 420, 440 are stamped from a 12-14 gauge piece of sheet metal, although other gauges are within the scope of the present disclosure. It is understood that any suitable material(s) may be used to construct the attachment device 400.

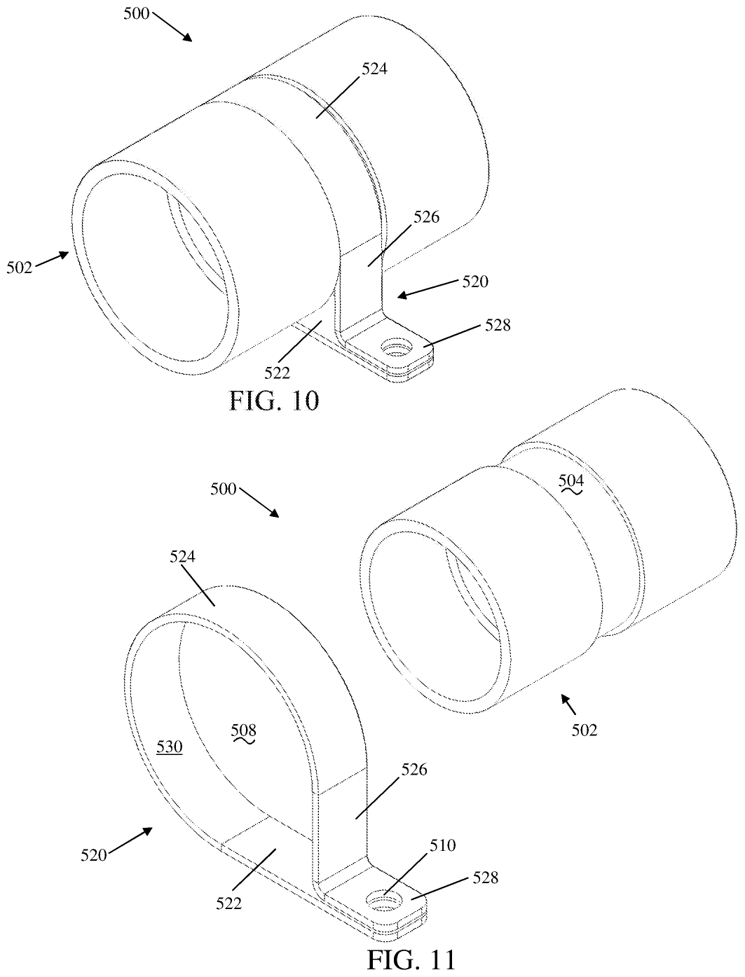

Referring to FIGS. 10 and 11, a fifth embodiment of an attachment device for coupling a non-structural component to a structural component, such as the sway brace/restraint 10, is generally indicated at reference numeral 500. The attachment device 500 is configured to be attached to the non-structural component, such as a pipe P, and to a structural component. The attachment device 500 includes a first attachment device member 502 and a second attachment device member 520. The illustrated first attachment device member 502 is a pipe fitting configured to receive and connect to pipes. Generally, fittings can include grooves, threads or are configured for a press-fit engagement with the non-structural component to attach the fitting to the non-structural component. Accordingly, the first attachment device member 502 is configured to be part of the non-structural component system, such as a part of the pipe system. The illustrated first attachment device member 502 is a coupling fitting. In other embodiments, the first attachment device member 502 may be a tee fitting, cross fitting, cap fitting, elbow fitting or any other fitting used with the non-structural component. Fittings that connect to non-structural components, such as pipes, are known in the art and, thus, a detailed description is omitted here. However, as shown in FIGS. 10 and 11, the coupling fitting of the present disclosure is different from known or conventional fittings in that first attachment device member 502 includes a groove or channel 504 that is configured to receive the second attachment device member 520. The groove 504 extends circumferentially around the first attachment device member 502 and is sized and shaped to correspond to the size and shape of the second attachment device member 520. The groove 504 has a depth (e.g., distance between the exterior surface of the first attachment device member and the base of the groove) that is equal to or greater than a thickness of the second attachment device member 520, a width (e.g., distance between the sides of the groove) that is equal to or greater than a width of the second attachment device member, and a radius (e.g., distance between the center of the first attachment device member and the base of the groove) that is equal to or less than an inner radius of the second attachment device member. In the illustrated embodiment, the groove 504 is centered on the first attachment device member 502. In other embodiments, the groove 504 may be at other locations on the first attachment device member 502, such as off-center or near an end of the first attachment device member.

The second attachment device member 520 is configured to be received in the groove 504 and circumferentially extend around the first attachment device member. The second attachment device member 520 includes a generally planar base portion 522 extending generally horizontally from a free end of the base portion, a central arcuate portion 524 extending from the base portion, a straight portion 526 extending generally vertically from the central arcuate portion toward the base portion, and a connection tab 528 extending generally horizontally from the straight portion to a free end. The connection tab 528 is generally parallel to, engages and overlies a section of the base portion 522. The base portion 522, central arcuate portion 524, and straight portion 526 define a receiving space 508 configured to receive the first attachment device member 502 (e.g., extend into and through the groove 504). The connection tab 528 and base portion 522 each define a fastener opening 510 that receive a fastener (e.g., fastener assembly—bolt, nut, washers) (broadly, a fastening component) to connect the connection tab and base portion together. Other ways of securing the connection tab 528 and base portion 522 together are within the scope of the present disclosure. The fastener openings 510 of the connection tab 528 and base portion 522 are aligned such that a single fastener (not shown) can be inserted there through. The fastener that extends through connection tab 528 and base portion 522 is also used to connect the attachment device 500 (specifically, the second attachment device member 520) to a structural component. The connection tab 528 and base portion 522, individually and/or in combination, is/are, broadly, an attachment component for attaching the attachment device to the structural component. In one embodiment, additional connection tabs 528 extend radially outward from the second attachment device member 520 to create additional mounting points for the sway brace/restraint assembly.

The second attachment device member 520 is resiliently deflectable such that the connection tab 528 and base portion 522 can be separated and return back to their original position, shown in FIGS. 10 and 11. Specifically, the central arcuate portion 524 is resiliently deflectable to allow the connection tab 528 and base portion 522 to be manually separated, as described in more detail below. The central arcuate portion 524 forms approximately ¾ of a circle and has an inner radius measured to the inner surface 530 (broadly, a fastening component) of the central arcuate portion. The inner radius is smaller than the radius of the exterior surface of the fitting but equal to or, more preferably, larger than the radius of the groove 504. The second attachment device member 520 has a generally uniform thickness.

To attach the second attachment device member 520 to the first attachment device member 502, the connection tab 528 and base portion 522 are manually separated to increase the inner radius of the second attachment device member. By increase the inner radius, the second attachment device member 520 can slide over the exterior surface of the first attachment device member 502 and be positioned in the groove 504 (e.g., move the first attachment device member into the receiving space 508 of the second attachment device member). Once positioned in the groove 504, the connection tab 528 and base portion 522 will move back to their original position, in engagement with one another, and a fastener (not shown) can be inserted through the fastener openings 510 to secure the second attachment device member 520 on the first attachment device member and to secure a structural component to the attachment device 500. In one embodiment, the second attachment device member 520 is secured directly to a structural component of a building (e.g. a beam) by inserting the fastener (e.g. a screw) through the fastener openings 510 and into the structural component. Preferably, the inner radius of the second attachment device member 520 is larger than the radius of the groove 504 so that the second attachment device member does not apply any clamping force to the first attachment device member 502.

As shown in FIG. 10, when the second attachment device member 520 is positioned in the groove 504 (broadly, at least partially received in the groove) of the first attachment device member 502, the first attachment device member is prevented from moving longitudinally or laterally with respect to second attachment device member. That is, the inner surface 530 is positioned radially inward of the exterior surface of the first attachment device member such that the sides of the groove will engage the sides (e.g. edge margins) of the second attachment device member (more specifically, the base 522, central arcuate portion 524, and straight portion 526) to prevent the first attachment device member from moving longitudinally with respect to the second attachment device member. Similarly, the interior surface 530 of the second attachment device member 520 will contact the base of the groove 504 to prevent the first attachment device member 502 from moving laterally with respect to the second attachment device member. Thus, the attachment device 500 is configured to be attached to the non-structural component in a manner that does not compress (e.g., deform) the non-structural component while inhibiting movement of the non-structural component (relative to the attachment device).

The first attachment device member 502 can be made from metal (e.g., steel, copper), plastic (e.g., thermoplastic, polyvinyl chloride, chlorinated polyvinyl chloride), or any other material fittings used with the non-structural component are made of In one embodiment, the second attachment device member 520 is formed from a single piece of material, such as a metal blank that is stamped from a piece of sheet metal and bent into shape. In one embodiment, the second attachment device member 520 is stamped from a 12-14 gauge piece of sheet metal, although other gauges are within the scope of the present disclosure. It is understood that any suitable material(s) may be used to construct the second attachment device member 520.

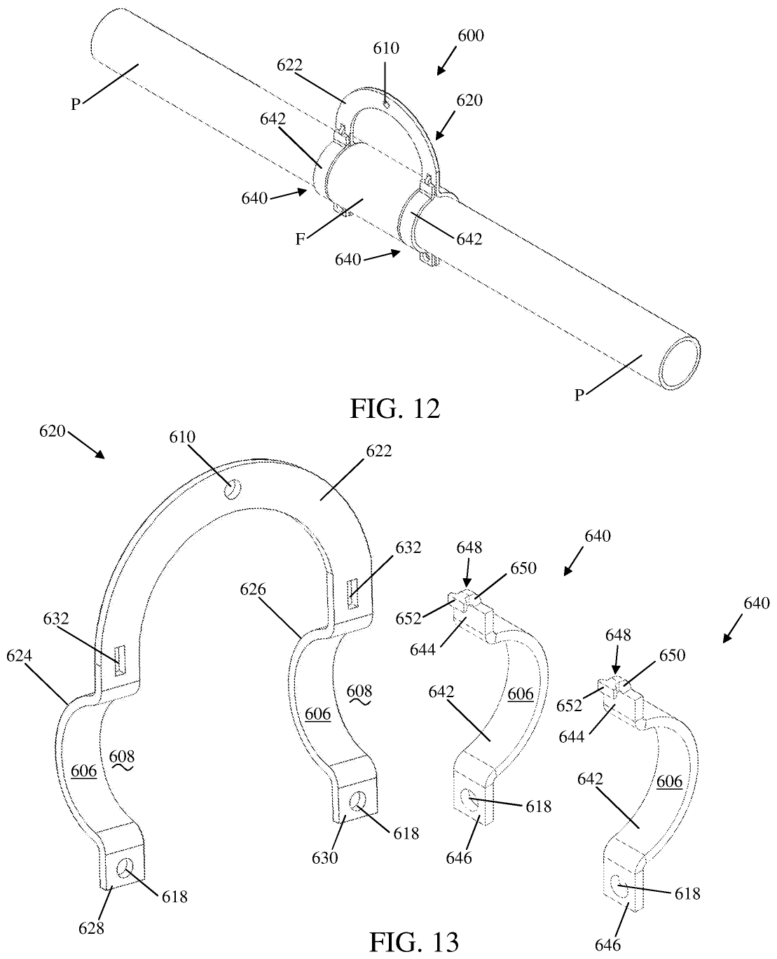

Referring to FIGS. 12 and 13, a sixth embodiment of an attachment device for coupling a non-structural component to a structural component, such as the sway brace/restraint 10, is generally indicated at reference numeral 600. The attachment device 600 is configured to be attached to the non-structural components, such as a pipes P that are attached to a fitting F, and to a structural component. The attachment device 600 includes a first attachment device member 620 and a pair of second attachment device members 640. The pair of second attachment device members 640 are configured to be connected to the first attachment device member 620 such that the attachment device 600 circumferentially extends around the pipe P in two, spaced apart locations. When the first and second attachment device members 620, 640 are connected together, they define two receiving spaces 608 longitudinally spaced apart that are sized and shaped to receive the non-structural component, such as pipe P, on either side of the fitting F.

The first attachment device member 620 includes a central arch portion 622 with opposite ends (e.g., bases), first and second arcuate portions 624 and 626, respectively, extending from each end of the central arch portion, and planar first and second connection tabs 628, 630 extending vertically downward from an end of each arcuate portion to a free end. Generally, the central arch portion 622 and first and second connection tabs 628, 630 lie in the same vertical plane (e.g., are coplanar) and the curve of the first and second arcuate portions 624, 626 extending out of plane with the arch portion 622 and the tabs 628, 630. The central arch portion 622 separates the first and second arcuate portions 624, 626 (each broadly, an attachment member) by a distance that is equal to or greater than the longitudinal distance between opposite ends of the fitting F. The illustrated central arch portion 622 defines a fastener opening 610 at the top of the arch configured to receive a fastener (not shown) to connect the restrain 600 to the structural component. The central arch portion 622 is, broadly, an attachment component for attaching the attachment device to the structural component. In other embodiments, the fastener opening 610 may be at a different location on the first attachment device member 620 and/or the first attachment device member may include additional fastener openings. Each base of the central arch portion 622 defines a generally vertically oriented opening or slot 632 (broadly, a female interlocking member or portion) extending through the central arch portion and configured to receive a portion of one of the second attachment device members 640 to connect the two members together. As described in more detail below, each second attachment device member 640 is configured to interlock with the first attachment device member 620 via the slots 632. In one embodiment, the first arcuate portion 624, the tab 628 and the base of the central arch portion 622 extending from the first arcuate portion are together, broadly, an attachment member. Similarly, the second arcuate portion 626, the tab 630 and the base of the central arch portion 622 extending from the second arcuate portion are together, broadly, another attachment member. In another embodiment, only the first and second arcuate portions 624, 626 are each, broadly, attachment members.

The first and second arcuate portions 624, 626 are each configured to partially circumferentially extend around the non-structural component. Each arcuate portions 624, 626 has an interior surface 606 (broadly, a fastening component) that partially defines the receiving space 608 sized and shaped to receive the non-structural component. In the illustrated embodiment, the first and second arcuate portions 624, 626 are each sized and shaped to extend, circumferentially, around approximately ½ of the pipe P. The first and second arcuate portions 624, 626 are each curved to correspond to the size and shape of the pipe P such that the interior surface 606 is concave and curved to correspond to the exterior surface of the pipe.

The second attachment device members 640 are identical and are each configured to be attached to the first attachment device member 620 and to close, circumferentially, each receiving space 608. Each second attachment device member 640 includes a central arcuate portion 642 and planar upper and lower connection tabs 644 and 646, respectively, extending vertically from each end of the central arcuate portion. In one embodiment, the second attachment device member 640 is, broadly, an attachment member. In another embodiment, the central arcuate portion 642 is, broadly, an attachment member. The upper connection tab 644 extends vertically upward and the lower connection tab 646 extends vertically downward to a free end from the central arcuate portion 642. The second attachment device members 640 each include an interlocking portion 648 (e.g., male interlocking portion or member) extending from the upper connection tab 644. The interlocking portion 648 is configured to interlock with the first attachment device member 620 to connect the second attachment device member 640 to the first attachment device member. The interlocking portion 648 includes an extension member 650 extending from the upper connection tab 644 and configured to extend through the slot 632 in the central arch portion 622 and a wedge member 652 attached to the end of the extension member and configured to engage the central arch portion to interlock the first and second restrain members 620, 640 together. The wedge member 652 is configured to be inserted through the slot 632. Specifically, the wedge member 652 has a height that is less than the width of the slot 632 and a width that is less than the height of the slot such that the wedge member can pass through the slot when the second attachment device member 640 is rotated approximately 90° from the orientation shown in FIG. 13 (e.g., generally horizontal). However, the width of the wedge member 652 is greater than the width of the slot 632 such that when the interlocking portion 648 is inserted through the slot and the second attachment device member is in the orientation show in FIGS. 12-13 (e.g., generally vertical) the wedge member cannot pass back through the slot. In this manner, each second attachment device member 640 interlocks with the first attachment device member 620. The central arcuate portions 642 of the second attachment device members 640 are configured to partially circumferentially extend around the non-structural component and have an interior surface 606 that partially define the receiving spaces 608 sized and shaped to receive the non-structural component. In the illustrated embodiment, the central arcuate portions 642 are sized and shaped to extend, circumferentially, around approximately ½ of the pipe P. The central arcuate portions 742 are curved to correspond to the size and shape of the pipe P and such that the interior surfaces 606 are concave and curved to correspond to the exterior surface of the pipe.

Each lower connection tab 646 of the second attachment device members 640 is configured to attach to one of the first and second connection tabs 628, 630 of the first attachment device member 620. In the illustrated embodiment, each connection tab 628, 630, 646 defines a fastener opening 618 that receives a fastener (e.g., fastener assembly—bolt, nut, washers) (broadly, a fastening component) to connect the respective connection tabs together. When connected together, the interlocking portion 648 of the second attachment device member 640 interlocks with the slot 632 of the first attachment device member and the fastener openings 618 in the connection tabs 628, 630, 646 are aligned such that fasteners (not shown) can be inserted there-through to secure the first and second attachment device members 620, 640 together. It is understood that other ways of attaching the connection tabs 628, 630, 646 to one another, such as with adhesive, tape, and/or clamps, are within the scope of the present disclosure.

As shown in FIG. 12, to attach the attachment device 600 to the non-structural component, the interlocking portions 648 of each second attachment device member is first interlocked with the first attachment device member 620 and then the attachment device 600 is positioned over a fitting F attached to the non-structural components (e.g., pipes P attached to each end of the fitting) such that the non-structural components extending from either end of the fitting are received in the two receiving spaces 608, with the fitting positioned there between. In the illustrated embodiment, the attachment device 600 is positioned over a coupling fitting F that connects two pipes P together. In other embodiments the fitting F may be a tee fitting, cross fitting, cap fitting, elbow fitting or any other fitting used with non-structural components. When the second attachment device members 640 are interlocked with the first attachment device member 620, the second attachment device members can rotate or tilt upward to facilitate the positioning of the attachment device 600 over the non-structural components. Once the attachment device 600 is positioned, fasteners (not shown) are inserted through the fastener openings 618 to secure the second attachment device members 640 to the first attachment device member 620, thereby securing the attachment device 600 on the non-structural component. When connected together, the upper connection tab 644 engages the base of the central arch portion 622 and the lower connection tab 646 engages one of the first or second connection tabs 628, 630.

When the first and second attachment device members 620, 640 are attached together, they define the two receiving spaces 608 sized and shaped to receive the non-structural component (e.g., pipe P). In one embodiment, the receiving spaces 608 are oversized (e.g., slightly larger) than the non-structural component such that the attachment device 600 applies no or substantially no clamping force to the non-structural component. In this embodiment, the arcuate portions 624, 626, 642 of the first and second attachment device members 620, 640 have a radius (to the inner surface 606) that is larger than the radius (to the exterior surface of the pipe) of the pipe P but smaller than the radius (to the exterior surface of the fitting) of the fitting. These dimensions ensure that the attachment device 600 will apply little to no clamping force against the pipes P but that any longitudinal movement of the pipes will be inhibited by the engagement between the fitting and attachment device. Specifically, the arcuate portions 624, 626, 642 of the first and second attachment device members 620, 640 positioned on either side of the fitting F will engage the end of the fitting to prevent longitudinal movement of the non-structural components. It is appreciated that because the attachment device 600 surrounds the pipe P, the attachment device also inhibits lateral movement of the pipe. In another embodiment, the receiving spaces 608 are still oversized (e.g., slightly larger) to apply little to no clamping force to the non-structural component but the arcuate portions 624, 626, 642 of the first and second attachment device members 620, 640 include an adhesive (broadly, a fastening component) thereon, as described above, to bond the attachment device 600 to the non-structural component. In still another embodiment, the receiving spaces 608 are still oversized (e.g., slightly larger) to apply little to no clamping force to the non-structural component but the attachment device 600 includes a compressible member, as described above, between the non-structural component and the first and second attachment device members to grip the non-structural component. In this embodiment, the compressible member can be a single compressible member that spans over the pipe P into both receiving spaces 608 or each receiving space may have its own compressible member. Thus, the attachment device 600 is configured to be attached to the non-structural component in a manner that does not compress or deform the non-structural component while inhibiting movement of the non-structural component (relative to the attachment device).

In one embodiment, the first and second attachment device members 620, 640 of the attachment device 600 are formed from a single piece of material, such as a metal blank that is stamped from a piece of sheet metal and bent into shape. In one embodiment, the attachment device members 620, 640 are stamped from a 12-14 gauge piece of sheet metal, although other gauges are within the scope of the present disclosure. It is understood that any suitable material(s) may be used to construct the first and second attachment device members 620, 640.

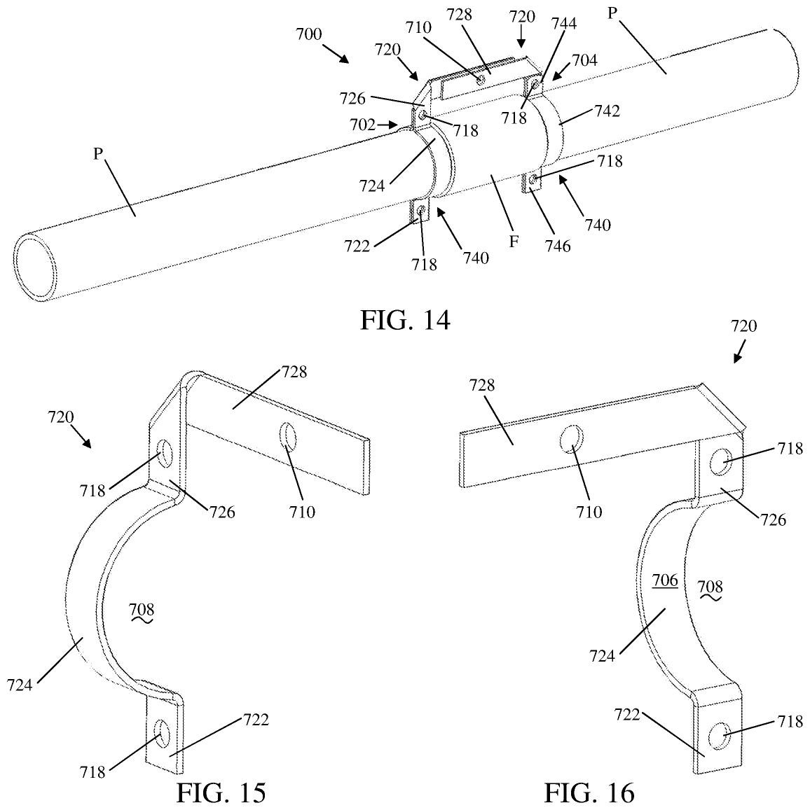

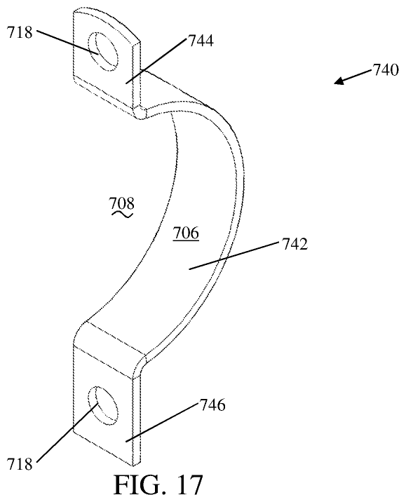

Referring to FIGS. 14-17, a seventh embodiment of an attachment device for coupling a non-structural component to a structural component, such as the sway brace/restraint 10, is generally indicated at reference numeral 700. The attachment device 700 is configured to be attached to the non-structural components, such as a pipes P that are attached to a fitting F and to a structural component. The attachment device 700 includes first and second attachment device member assemblies 702 and 704, respectively. Each attachment device member assembly 702, 704 includes first and second attachment device members 720 and 740, respectively. Each attachment device member assembly 702, 704 is configured to be connected to the non-structural component (e.g., pipe P) adjacent the fitting F. The first and second attachment device members 720, 740 of each attachment device member assembly 702, 704 are configured to be connected together such that they circumferentially extend around the pipe P. Because the attachment device 700 has two attachment device member assemblies 702, 704 and, therefore, two sets of first and second attachment device members 720, 740, the attachment device is configured to connect to the non-structural component in two, spaced apart locations, which, as shown in FIG. 14, are on either side of the fitting F. When the first and second attachment device members 720, 740 are connected together, they define a receiving space 708 sized and shaped to receive the non-structural component, such as pipe P.

The first attachment device member 720 includes a planar connection tab 722 extending generally vertically from a free end of the connection tab, an arcuate portion 724 extending from the connection tab, a planar first straight portion 726 extending generally vertically upward from the arcuate portion, and a planar second straight portion 728 extending generally horizontally from the first straight portion to a free end. The second straight portion 728 is offset with respect to the first straight portion 726 such that the first and second straight portions lie in spaced apart planes that are generally parallel with one another. The second straight portion 728 is generally perpendicular to the first straight portion 726 (e.g., their respective lengths are perpendicular to one another) and extends to one side thereof. The illustrated second straight portion 728 defines a fastener opening 710 configured to receive a fastener (not shown) that connects the pair of first attachment device members 720 together and connects the attachment device 700 to the structural component. The second straight portion 728 is, broadly, an attachment component for attaching the attachment device to the structural component. In other embodiments, the fastener opening 710 may be at a different location on the second straight portion 728 and/or the second straight portion may include additional fastener openings. The arcuate portion 724 is configured to partially circumferentially extend around the non-structural component. The arcuate portion 724 has an interior surface 706 (broadly, a fastening component) that partially defines the receiving space 708 sized and shaped to receive the non-structural component. In the illustrated embodiment, the arcuate portion 724 is sized and shaped to extend, circumferentially, around approximately ½ of the pipe P. The arcuate portion 724 is curved to correspond to the size and shape of the pipe P such that the interior surface 706 is concave and curved to correspond to the exterior surface of the pipe. In one embodiment, the arcuate portion 724, the first straight portion 726 and tab 722 are together, broadly, an attachment member. In another embodiment, only the arcuate portions 724 is, broadly, an attachment member.

The second attachment device member 740 is configured to be attached to the first attachment device member 720 and to close, circumferentially, each receiving space 708 to secure the attachment device assemblies 702, 704, and thereby the attachment device 700, to the non-structural component. The second attachment device member 740 includes a central arcuate portion 742 and planar upper and lower connection tabs 744 and 746, respectively, extending vertically from each end of the central arcuate portion to a free end. In one embodiment, the second attachment device member 740 is, broadly, an attachment member. In another embodiment, the central arcuate portion 742 is, broadly, an attachment member. The upper connection tab 744 extends vertically upward from one end of the central arcuate portion 742 and the lower connection tab 746 extends vertically downward from the other end of the central arcuate portion. The central arcuate portion 742 is configured to partially circumferentially extend around the non-structural component and has an interior surface 706 that partially defines the receiving space 708 sized and shaped to receive the non-structural component. In the illustrated embodiment, the central arcuate portion 742 is sized and shaped to extend, circumferentially, around approximately ½ of the pipe P. The central arcuate portion 742 is curved to correspond to the size and shape of the pipe P and such that the interior surface 706 is concave and curved to correspond to the exterior surface of the pipe.

The upper connection tab 744 of the second attachment device member 740 and the first straight portion 726 of the first attachment device member 720 are configured to attach to each other. Similarly, the lower connection tab 746 of the second attachment device member 740 and the connection tab 722 of the first attachment device member 720 are configured to attach to each other. In the illustrated embodiment, each of the first straight portion 726 and connection tabs 722, 744, 746 define a fastener opening 718 that receives a fastener (e.g., fastener assembly—bolt, nut, washers) (broadly, a fastening component) to connect the first and second attachment device members 720, 740 together. When connected together, the fastener openings 718 in the first straight portion 726 and upper connection tab 744 are aligned and the fastener openings in the connection tabs 722, 746 are aligned such that fasteners (not shown) can be inserted there-through. It is understood that other ways of attaching the first and second attachment device members 720, 740 to one another, such as with adhesive, tape, and/or clamps, are within the scope of the present disclosure. For example, the first and second attachment device members 720, 740 can include slots and interlocking portions to connect to one another, as described above.

As shown in FIG. 14, to attach the attachment device 700 to the non-structural component, the first and second attachment device members 720, 740 of the first attachment device assembly 702 are positioned over the non-structural component (e.g., pipe P) on one side of the fitting F and the first and second attachment device members 720, 740 of the second attachment device assembly 704 are positioned over the non-structural component on the other side of the fitting. Once the attachment device assemblies 702, 704 are positioned, fasteners (not shown) are inserted through the fastener openings 718 to secure the first and second attachment device members 720, 740 together, thereby securing the attachment device assembly on the non-structural component. When connected together, the upper connection tab 744 engages the first straight portion 726 and the lower connection tab 746 engages the connection tab 722.

The first and second attachment device assemblies 702, 704 are identical (e.g., both include first and second attachment device members 720, 740) but when attached to the non-structural components, one of attachment device assemblies is rotated about a vertical axis 180° (e.g., turned around). In this arrangement, the second straight portions 728 of each attachment device assembly 702, 704 extend toward, engage and overlap one another, as shown in FIG. 14. The offset arrangement of the second straight portion 728 relative to the first straight portion 726 provides a flatter engagement between the second straight portions of first and second attachment device assemblies 702, 704. The first and second attachment device assemblies 702, 704 are moved longitudinally with respect to one another to align the fastener openings 710 therein so that a fastener (not shown) can be inserted there-through to secure the first and second attachment device assemblies together and connect the attachment device 700 to a structural component. In one embodiment, the second straight portion 728 includes a line of fastener openings 710 such that an operator can choose the fastener openings to align. In this manner, the operator can set the longitudinal distance between the receiving spaces 708 of the attachment device assemblies 702, 704 to accommodate fittings F of different longitudinal lengths. As shown in FIG. 14, when the attachment device 700 is positioned over fitting F, the non-structural components (e.g., pipes P) extending from either side of the fitting are received in the receiving spaces 708 defined by the first and second attachment device assemblies 702, 704, the fitting positioned there between. In the illustrated embodiment, the attachment device 700 is positioned over a coupling fitting F that connects two pipes P together. In other embodiments the fitting F may be a tee fitting, cross fitting, cap fitting, elbow fitting or any other fitting used with non-structural components.

When the first and second attachment device members 720, 740 are attached together, they define the two receiving spaces 708 sized and shaped to receive the non-structural component (e.g., pipe P). In one embodiment, the receiving spaces 708 are oversized (e.g., slightly larger) than the non-structural component such that the attachment device 700 applies no or substantially no clamping force to the non-structural component. In this embodiment, the arcuate portions 724, 742, of the first and second attachment device members 720, 740 have a radius (to the inner surface 706) that is larger than the radius (to the exterior surface of the pipe) of the pipe P but smaller than the radius (to the exterior surface of the fitting) of the fitting F. These dimensions ensure that the attachment device 700 will apply little to no clamping force against the pipes P but that any longitudinal movement of the pipes will be inhibited by the engagement between the fitting F and attachment device. Specifically, the arcuate portions 724, 742 of the first and second attachment device members 720, 740 positioned on either side of the fitting F will engage the end of the fitting to prevent longitudinal movement of the non-structural components. It is appreciated that because the attachment device 700 surrounds the pipe P, the attachment device also inhibits lateral movement of the pipe. In another embodiment, the receiving spaces 708 are still oversized (e.g., slightly larger) to apply little to no clamping force to the non-structural components but the arcuate portions 724, 742 of the first and second attachment device members 720, 740 include an adhesive (broadly, a fastening component) thereon, as described above, to bond the attachment device 700 to the non-structural component. In still another embodiment, the receiving spaces 708 are still oversized (e.g., slightly larger) to apply little to no clamping force to the non-structural components but the attachment device 700 includes a compressible member, as described above, between the non-structural component and the first and second attachment device members to grip the non-structural component. In this embodiment, the compressible member can be a single compressible member that spans over the pipe P into both receiving spaces 708 or each receiving space may have its own compressible member. Thus, the attachment device 700 is configured to be attached to the non-structural component in a manner that does not compress or deform the non-structural component while inhibiting movement of the non-structural component (relative to the attachment device).

In one embodiment, the first and second attachment device members 720, 740 of the attachment device 700 are formed from a single piece of material, such as a metal blank that is stamped from a piece of sheet metal and bent into shape. In one embodiment, the attachment device members 720, 740 are stamped from a 12-14 gauge piece of sheet metal, although other gauges are within the scope of the present disclosure. It is understood that any suitable material(s) may be used to construct the first and second attachment device members 720, 740.

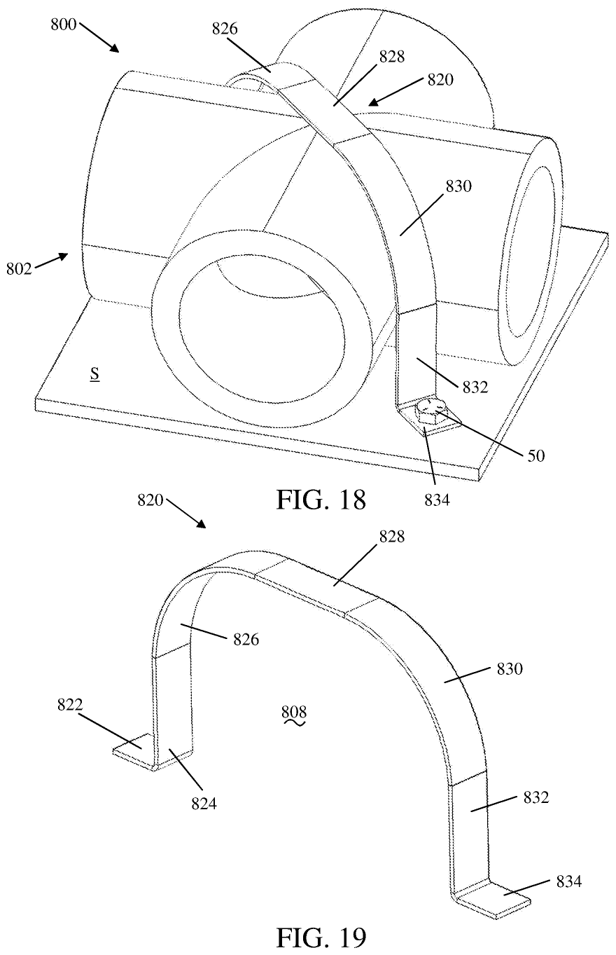

Referring to FIGS. 18 and 19, an eight embodiment of an attachment device for coupling a non-structural component to a structural component, such as a structural element S of a building, is generally indicated at reference numeral 800. The attachment device 800 is configured to be attached to the non-structural component, such as a pipe P, and to a structural component. The illustrated structural element S of the building can be a beam, roof, floor, ceiling, etc. The attachment device 800 includes a first attachment device member 802 and a second attachment device member 820. The first attachment device member 802 is a fitting configured to receive and connect to non-structural components, as generally known in the art and described above, except that in the illustrated embodiment, the first attachment device member is a cross fitting. The cross fitting 802 includes four corners defined by attachment portions of the fitting, each attachment portion is configured to couple to one of the non-structural components. A crosswise distance between opposite corners is less than a longitudinal distance between outward ends of opposite attachment portions. In other embodiments, the first attachment device member 802 may be a tee fitting, coupling fitting, cap fitting, elbow fitting or any other fitting used with the non-structural component.

The second attachment device member 820 is configured to extend over the first attachment device member 802 and to be attached to the structural component S. The second attachment device member 820 is sized and shaped such that the second attachment device member does not compress or clamp the first attachment device member 802 against the structural component S. Instead, the second attachment device member 820 is in a close fitting relationship with the first attachment device member 802 such that when the second attachment device member is secured or fixed to the structural component S, the second attachment device member inhibits movement of the first attachment device member. The second attachment device member 820 includes a generally planar central straight portion 828 extending generally horizontally between opposite ends, first and second arcuate portions 826 and 830, respectively, extending from each end of the central straight portion and curved in a downward direction, planar first and second straight portions 824 and 832, respectively, extending generally vertically downward from each end of the first and second arcuate portions, respectively, and planar first and second connection tabs 822 and 834, respectively, extending generally horizontally away from each other from each end of the first and second straight portions, respectively. The second attachment device member 820 is symmetrical about a vertical plane extending through the central straight portion 828 (symmetrical about a plane both parallel and normal to the central straight portion). The central straight portion 828, first and second arcuate portions 826, 830, and first and second straight portions 824, 832 define a receiving space 808 configured to receive the first attachment device member 802. Each connection tab 822, 834 defines a fastener opening (not shown) that receives a fastener 50 (e.g., bolt, screw, etc.) (broadly, a fastening component) to mount the second attachment device member 820 to the structural component S. Each connection tab 822, 834 is, broadly, an attachment component for attaching the attachment device to the structural component. Each fastener 50 extends through the first or second connection tab 822, 834 and into the structural component S. Other ways of mounting the second attachment device member 820 to the structural component S are within the scope of the present disclosure. In another embodiment, the fasteners 50 are used to connect the second attachment device member 820 to a sway brace/restraint. The second attachment device member 820 has a generally uniform thickness.

As shown in FIG. 18, when the second attachment device member 820 is positioned over (e.g., attached to) the first attachment device member 802, the first attachment device member is prevented from moving longitudinally or laterally with respect to second attachment device member. That is, any contact between the first and second attachment device members 802, 820 prevents the first attachment device member, and any non-structural component attached to the first attachment device member, from moving. In this embodiment, the non-structural component (e.g., pipe attached to the first attachment device member 802) is supported by the support surface S and the attachment device 800 acts as a brace or restraint that is attached to the support surface to inhibit the pipe from moving. The receiving space 808 is, preferably, oversized (e.g., slightly larger) than the first attachment device member 802 such that the second attachment device member applies little to no clamping force to the first attachment device member (e.g., fitting of the non-structural component system). Thus, the attachment device 800 is configured to be attached to the structural component S in a manner that does not compress (e.g., deform) the non-structural component while inhibiting movement of the non-structural component relative to the attachment device 800. The receiving space 808 has a width greater than the crosswise distance and less than the longitudinal distance. Accordingly, any engagement between the first and second attachment device members 802, 820, generally at the corners of the cross fitting, inhibit movement of the fitting. It will be further understood that the first attachment device member 802 may be considered a non-structural component and the second attachment device member 820 alone may be considered the attachment device that secures the non-structural component to the structural component S in a manner that does not compress (e.g., deform) the non-structural component while inhibiting movement of the non-structural component relative to the attachment device.

In one embodiment, the second attachment device member 820 is formed from a single piece of material, such as a metal blank that is stamped from a piece of sheet metal and bent into shape. In one embodiment, the second attachment device member 820 is stamped from a 12-14 gauge piece of sheet metal, although other gauges are within the scope of the present disclosure. It is understood that any suitable material(s) may be used to construct the second attachment device member 820.

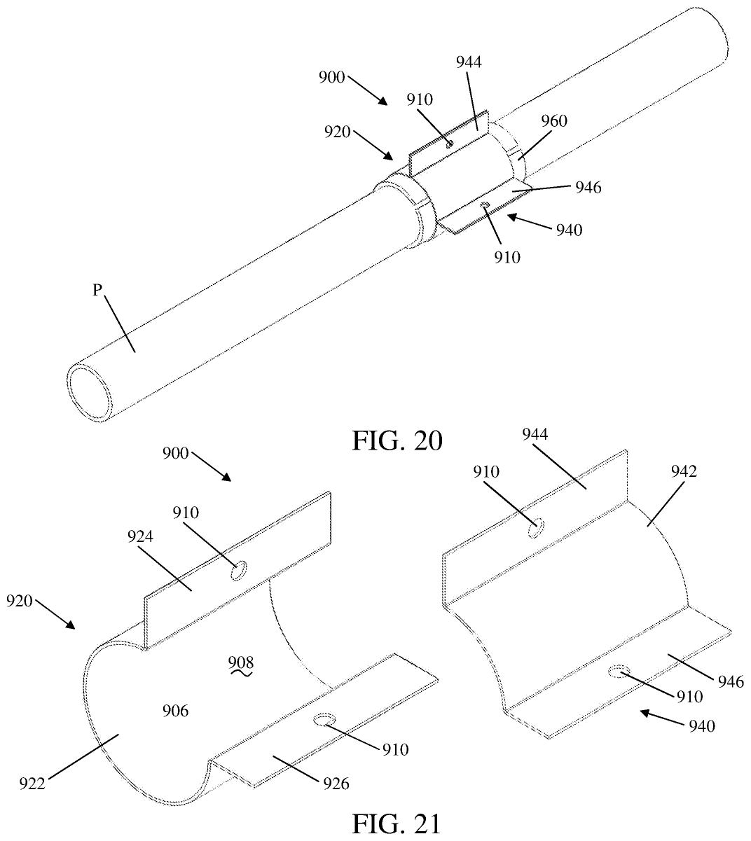

Referring to FIGS. 20 and 21, a ninth embodiment of an attachment device for coupling a non-structural component to a structural component, such as the sway brace/restraint 10, is generally indicated at reference numeral 900. The attachment device 900 is configured to be attached to the non-structural component, such as a pipe P, and to a structural component. The attachment device 900 includes a first attachment device member 920 and a second attachment device member 940. The first and second attachment device members 920, 940 are configured to be connected to one another such that they circumferentially extend around the pipe P. When the first and second attachment device members 920, 940 are connected together, they define a receiving space 908 sized and shaped to receive the non-structural component, such as pipe P. As shown in FIG. 20, the attachment device 900 also includes a compressible member 960 configured to be inserted between the first and second attachment device members 920, 940 and the non-structural component, as described in more detail below.

The first attachment device member 920 includes a central arcuate portion 922 with opposite edge margins (e.g., ends), and first and second connection flanges 924 and 926, respectively, extending radially outward from each edge margin of the central arcuate portion. The central arcuate portion 922 is configured to partially circumferentially extend around the non-structural component and has an interior surface 906 (broadly, a fastening component) that partially defines the receiving space 908 sized and shaped to receive the pipe P. In the illustrated embodiment, the central arcuate portion 922 extends, circumferentially, around approximately ¾ of the pipe P. In other embodiments, the central arcuate portion 922 may circumferentially extend around more or less of the pipe P. The central arcuate portion 922 is curved to correspond to the size and shape of the pipe P such that the interior surface 906 is concave and curved to correspond to the exterior surface of the pipe. In the illustrated embodiment, the first and second connection flanges 924, 926 extend along the entire length of the central arcuate portion 922. In another embodiment, the first and second connection flanges 924, 926 extend along only a portion of the length of the central arcuate portion 922.

The second attachment device member 940 is similar to the first attachment device member 920 and includes a central arcuate portion 942 and first and second connection flanges 944 and 946, except that the central arcuate portion of the second attachment device member is configured to circumferentially extend around the circumferential portion of the non-structural component the central arcuate portion 922 of the first attachment device member does not circumferentially extend around. In other words, when the first and second attachment device members 920, 940 are connected together, the combination of the central arcuate portions 922, 942 circumferentially extend around the entire pipe P. In the illustrated embodiment, the central arcuate portion 942 extends, circumferentially, around approximately ¼ of the pipe P. In other embodiments, the central arcuate portion 942 may circumferentially extend around more or less of the pipe P, as a result of any changes to the portion of the pipe the central arcuate portion 922 circumferentially extends around. Otherwise, central arcuate portion 942 is the same as central arcuate portion 922 and first and second connection flanges 924, 926 are the same as first and second connection flanges 944, 946.

The first and second attachment device members 920, 940 each have a length extending between opposite ends of their respective central arcuate portions 922, 942 (e.g., generally parallel to a longitudinal axis of the pipe P) that is, preferably, at least two times greater than a diameter of the pipe and a diameter of the combined arcuate portions. This dimension provides the interior surfaces 906 of the central arcuate portions 922, 942 with a large surface area for reasons described herein.

The first and second connection flanges 924, 926 of the first attachment device member 920 are configured to attach to the first and second connection flange 944, 946 of the second attachment device member 940. Each connection flange 924, 926, 944, 946 defines at least one fastener opening 910 that receives a fastener (e.g., fastener assembly—bolt, nut, washers) (broadly, a fastening component) to connect the first and second attachment device members together 920, 940. When connected together, the fastener openings 910 in the first connection flanges 924, 944 are aligned and the fastener openings 910 in the second connection flanges 926, 946 are aligned, such that fasteners (not shown) can be inserted there through. It is understood that other ways of attaching the first and second attachment device members 920, 940 to one another, such as with adhesive, tape, and/or clamps, are within the scope of the present disclosure.

As shown in FIG. 20, when the first and second attachment device members 920, 940 are attached together, they define the receiving space 908 sized and shaped to receive the non-structural component, pipe P. Specifically, the interior surfaces 906 of the central arcuate portions 922, 942 of the first and second attachment device members 920, 940 define the receiving space 908. In this manner, the first and second attachment device members 920, 940 form a cylinder that circumferentially extends around the pipe P. The receiving space 908 is, preferably, oversized (e.g., slightly larger) than the non-structural component such that the attachment device 900 applies little to no clamping force to the non-structural component. In the illustrated embodiment, this means the receiving space 908 has a diameter that is larger (e.g., slightly larger) than the exterior diameter of the pipe P. Should the attachment device 900 apply any clamping force to the non-structural component, the large surface areas of the interior surfaces 906 of the first and second attachment device members 920, 940 sufficiently spread out the clamping force over a portion of the non-structural component to prevent the non-structural component from deforming. As shown in FIG. 20, the attachment device 900 includes the compressible member 960 that is positioned between the non-structural component (e.g., pipe P) and the first and second attachment device members 920, 940. Moreover, the deformation of the compressible member spreads any clamping force applied by the attachment device 900 to the non-structural component over a large portion of the non-structural component to prevent the non-structural component from deforming. The compressible member 960 is the same as compressible member 460, described above. The compressible member 960 can be a separate component that is inserted in between the attachment device 900 and the non-structural component before the attachment device is coupled to the pipe P or the compressible member can be a material or coating applied to the interior surfaces of the first and second members 920, 940. In another embodiment, the attachment device 900 includes adhesive (broadly, a fastening component), as described above, instead of the compressible member 960. In still another embodiment, adhesive can be applied to the interior surface of the compressible member 960. Thus, the attachment device 900 is configured to be attached to the non-structural component in a manner that does not compress or deform the non-structural component while inhibiting movement of the non-structural component (relative to the attachment device).

To attach the attachment device 900 to the non-structural component, the first attachment device member 920 is positioned over the pipe P. The first attachment device member 920 is resiliently deflectable so that the pipe P can be inserted through the space between the opposite edge margins of the central arcuate portion 922 by deflecting the opposite edge margins away from each other. Once the pipe P is positioned in the receiving space 908, the opposite edge margins return back to their original position. If compressible member 960 is a loose sheet of material, it would be positioned over the pipe P before the first attachment device member 920 is placed thereon so that the compressible member 960 is between the first attachment device member and the pipe. Once the first attachment device member 920 is on the pipe P, the second attachment device member 940 is moved into position and fasteners (not shown) are inserted through the fastener openings 910 to secure the first and second attachment device members 920, 940 together on the non-structural component. When the first and second attachment device members 920, 940 are connected together, the respective first connection flanges 924, 944 are engaged with one another and the respective second connection flanges 926, 946 are engaged with one another. In one embodiment, the fastener(s) extending through connection flanges 924, 926, 944, 946 is also used to connect the attachment device 900 to a structural component. Each connection flange 924, 926, 944, 946 is, broadly, an attachment component for attaching the attachment device to the structural component. In another embodiment, connection flanges 924, 926, 944, 946 include additional structure, such as additional fastener openings, to attach the attachment device 900 to a structural component. Each set of connection flanges can be connected to a structural component. In other embodiments, the attachment device 900 may have additional sets of connection flanges to connect to additional structural components. Further still, in other embodiments, the attachment device 900 may include more than two attachment device members (broadly, two or more attachment device members). For example, in one embodiment, the attachment device 900 is comprised of four second attachment device members 940 (each circumferentially extending ¼ of the way around the pipe P) connected together such that the attachment device has four sets of connection flanges and, therefore, four points of connection to a structural component. Still other numbers and constructions of attachment device members are envisioned.

In one embodiment, the first and second attachment device members 920, 940 of the attachment device 900 are formed from a single piece of material, such as a metal blank that is stamped from a piece of sheet metal and bent into shape. In one embodiment, the attachment device members 920, 940 are stamped from a 12-14 gauge piece of sheet metal, although other gauges are within the scope of the present disclosure. It is understood that any suitable material(s) may be used to construct the attachment device 900.

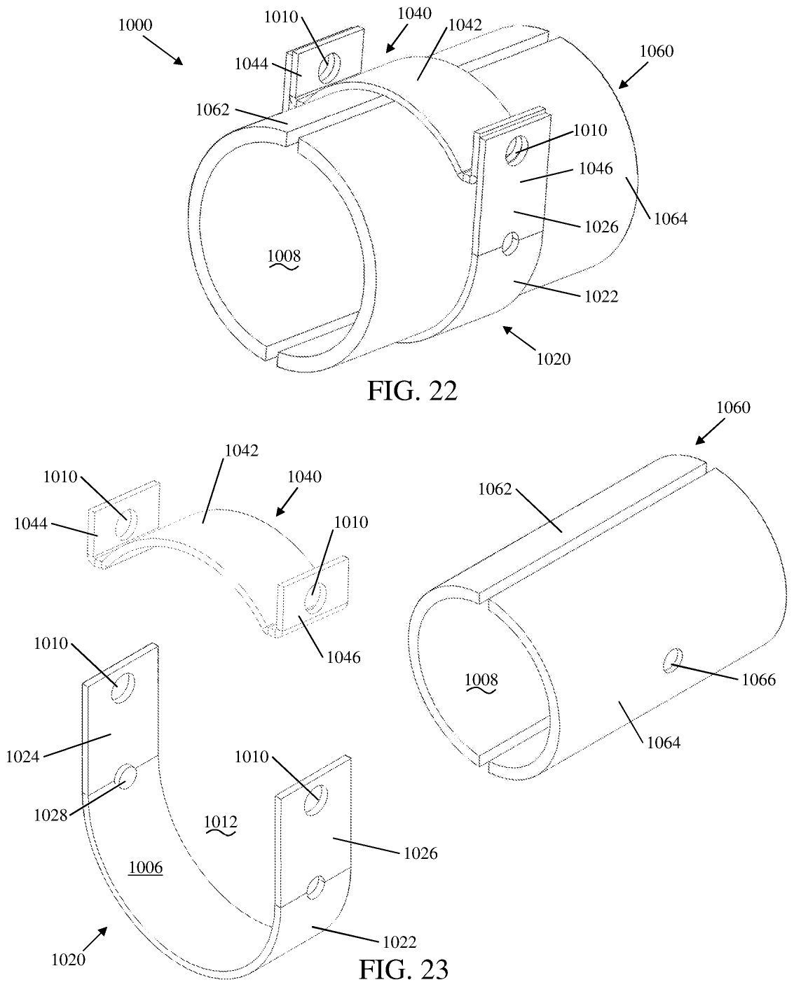

Referring to FIGS. 22-24, a tenth embodiment of an attachment device for coupling a non-structural component to a structural component, such as the sway brace/restraint 10, is generally indicated at reference numeral 1000. The attachment device 1000 is configured to be attached to the non-structural component, such as a pipe P, and to a structural component. The attachment device 1000 includes a first attachment device member 1020, a second attachment device member 1040, and a sleeve 1060 configured to circumferentially extend around the non-structural component. The first and second attachment device members 1020, 1040 are configured to be connected to one another such that they circumferentially extend around the sleeve 1060, and, therefore, the pipe P, to secure the attachment device 1000 to the non-structural component. The sleeve 1060 defines a receiving space 1008 sized and shaped to receive the non-structural component, such as pipe P. As shown in FIG. 22, the sleeve 1060 is configured to be inserted between the first and second attachment device members 1020, 1040 and the non-structural component, as described in more detail below.

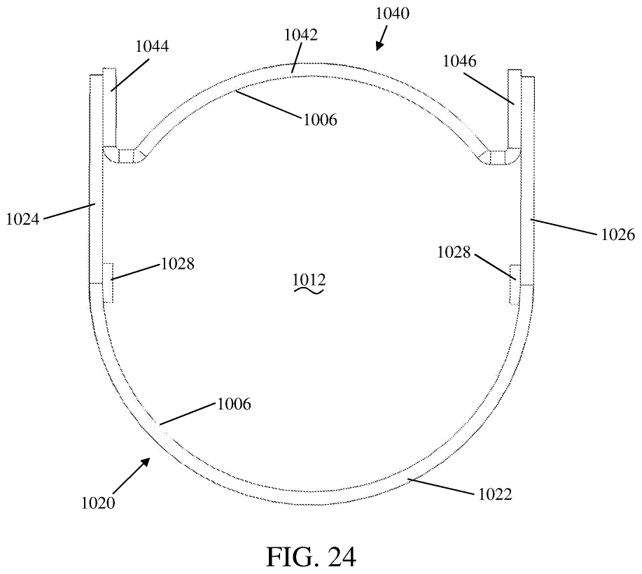

The first attachment device member 1020 is U-shaped and includes a central arcuate portion 1022 with opposite edge margins (e.g., ends), and planar first and second connection flanges 1024 and 1026, respectively, extending vertically upward from each edge margin of the central arcuate portion to a free end. The central arcuate portion 1022 is configured to partially circumferentially extend around the non-structural component and has an interior surface 1006 that partially defines a sleeve receiving space 1012 sized and shaped to receive the sleeve 1060. In the illustrated embodiment, the central arcuate portion 1022 is sized and shaped to extend, circumferentially, around approximately ½ of the pipe P. The central arcuate portion 1022 is curved to correspond to the size and shape of the pipe P and sleeve 1060 such that the interior surface 1006 is concave and curved to correspond to the exterior surface of the sleeve. The first attachment device member 1020 may include one or more projections 1028 that extend inward from an inner surface and are configured to engage the sleeve 1060. In the illustrated embodiment, the first attachment device member 1020 includes two projections 1028 positioned across from one another at each end of the central arcuate portion 1022 (FIG. 24). In other embodiments, the first attachment device member 1020 may have more or less projections 1028 and/or projections in other locations.

The second attachment device member 1040 is configured to be attached to the first attachment device member 1020 and close, circumferentially, the sleeve receiving space 1012 to secure the sleeve and the attachment device 1000 to the non-structural component. The second attachment device member 1040 includes a central arcuate portion 1042 and planar first and second connection flanges 1044 and 1046, respectively, extending vertically upward from each edge margin (e.g., end) of the central arcuate portion to a free end. The central arcuate portion 1042 is configured to partially circumferentially extend around the non-structural component and has an interior surface 1006 that partially defines the sleeve receiving space 1012 sized and shaped to receive the sleeve 1060. In the illustrated embodiment, the central arcuate portion 1042 is sized and shaped to extend, circumferentially, around approximately the top of the pipe P. The central arcuate portion 1042 is curved to correspond to the size and shape of the pipe P and sleeve 1060 such that the interior surface 1006 is concave and curved to correspond to the exterior surface of the sleeve.

The sleeve 1060 is configured to engage and grip the non-structural component. The sleeve 1060 (broadly, a fastening component) defines the receiving space 1008 that receives the non-structural component (e.g., pipe) to connect the attachment device 1000 to the non-structural component. The sleeve 1060 includes two sleeve members 1062 and 1064, respectively. Each sleeve member 1062, 1064 is semi-cylindrical in shape and configured to circumferentially extend around approximately half the pipe such that, together, the sleeve members extend around approximately the entire pipe. In other embodiments, the sleeve 1060 may only include only one sleeve member that is configured to circumferentially extend around approximately the entire pipe. Each sleeve member 1062, 1064 defines a recess 1066 sized and shaped to receive one of the projections 1028 of the first attachment device member 1020. In the illustrated embodiment, each sleeve member 1062, 1064 defines a single recess 1066 to receive one of the two projections 1028 of the first attachment device member 1020. It is understood that the sleeve 1060 can define any number of recess 1066 to receive however many projections 1028 the first attachment device member 1020 may have. As shown in FIG. 22, the recesses 1066 are positioned on the sleeve members 1062, 1064 such that when the sleeve 1060 is secured between the non-structural component and the first and second attachment device members 1020, 1040, the sleeve members do not overlap. The sleeve members 1062, 1064 each have a length extending between their respective opposite ends (e.g., generally parallel to a longitudinal axis of the pipe P) that is, preferably, at least two times greater than a diameter of the pipe and a diameter of the combined sleeve members. This dimension provides the sleeve members 1062, 1064 with a large interior surface area to engage the non-structural component with.

The first and second connection flanges 1024, 1026 of the first attachment device member 1020 are configured to attach to the first and second connection flange 1044, 1046 of the second attachment device member 1040. Each connection flange 1024, 1026, 1044, 1046 defines at least one fastener opening 1010 that receives a fastener (e.g., fastener assembly—bolt, nut, washers) (broadly, a fastening component) to connect the first and second attachment device members together 1020, 1040. When connected together, the fastener openings 1010 in the first connection flanges 1024, 1044 are aligned and the fastener openings in the second connection flanges 1026, 1046 are aligned, such that fasteners (not shown) can be inserted there-through to secure the first and second attachment device members 1020, 1040 together. It is understood that other ways of attaching the first and second attachment device members 1020, 1040 to one another, such as with adhesive, tape, and/or clamps, are within the scope of the present disclosure.

As shown in FIGS. 22 and 24, when the first and second attachment device members 1020, 1040 are attached together, they define the sleeve receiving space 1012 sized and shaped to receive the sleeve 1060, which, in turn, defines the receiving space 1008 sized and shaped to receive the non-structural component (e.g., pipe). In this manner, the first and second sleeve members 1062, 1064 form a cylinder that circumferentially extends around the non-structural component. In one embodiment, the receiving space 1008 is oversized (e.g., slightly larger) than the non-structural component such that the attachment device 1000 applies little to no clamping force to the non-structural component. In the illustrated embodiment, this means the receiving space 1008 has a diameter that is larger (e.g., slightly larger) than the exterior diameter of the pipe P. Should the attachment device 1000 apply any clamping force to the non-structural component, the large interior surface area of the sleeve 1060 will sufficiently spread out the clamping force over a portion of the non-structural component to prevent the non-structural component from deforming. In this embodiment, the sleeve 1060 is generally rigid and may include either an adhesive (broadly, a fastening component), as described above, to bond the attachment device 1000 to the non-structural component or a compressible member, as described above, to grip the non-structural component. In this embodiment, the sleeve 1060 can be made from any generally rigid material such as metal or a rigid plastic, such as polyvinyl chloride. In another embodiment, the sleeve 1060 is itself a compressible member, as described above, and is made from any suitable material that does not deform the non-structural component, such as rubber or a flexible plastic, such as chlorinated polyvinyl chloride. Thus, the attachment device 1000 is configured to be attached to the non-structural component in a manner that does not compress or deform the non-structural component while inhibiting movement of the non-structural component (relative to the attachment device).

To attach the attachment device 1000 to the non-structural component, the sleeve 1060 is positioned over the non-structural component (e.g., pipe) and then the first and second attachment device members 1020, 1040 are positioned over the sleeve such that the projections 1028 of the first attachment device member extend into the corresponding recesses 1066 of the sleeve. The engagement between the projections 1028 and recesses 1066 facilitates the positioning of the first and second attachment device members 1020, 1040 on the sleeve 1060 and helps hold the sleeve members 1062, 1064 in place. Once the first and second attachment device members 1020, 1040 are positioned over the sleeve 1060 and non-structural component, fasteners (not shown) are inserted through the fastener openings 1010 to secure the first and second attachment device members 1020, 1040 together, thereby securing the attachment device 1000 on the non-structural component. When the first and second attachment device members 1020, 1040 are connected together, the respective first connection flanges 1024, 1044 are engaged with each other and the respective second connection flanges 1026, 1046 are engaged with each other. One or both of the fasteners connecting the first and second attachment device members 1020, 1040 can be used to connect the attachment device 1000 to a structural component. Each connection flange 1024, 1026, 1044, 1046 is, broadly, an attachment component for attaching the attachment device to the structural component.

In one embodiment, the first and second attachment device members 1020, 1040 of the attachment device 1000 are formed from a single piece of material, such as a metal blank that is stamped from a piece of sheet metal and bent into shape. In one embodiment, the attachment device members 1020, 1040 are stamped from a 12-14 gauge piece of sheet metal, although other gauges are within the scope of the present disclosure. It is understood that any suitable material(s) may be used to construct the first and second attachment device members 1020, 1040.

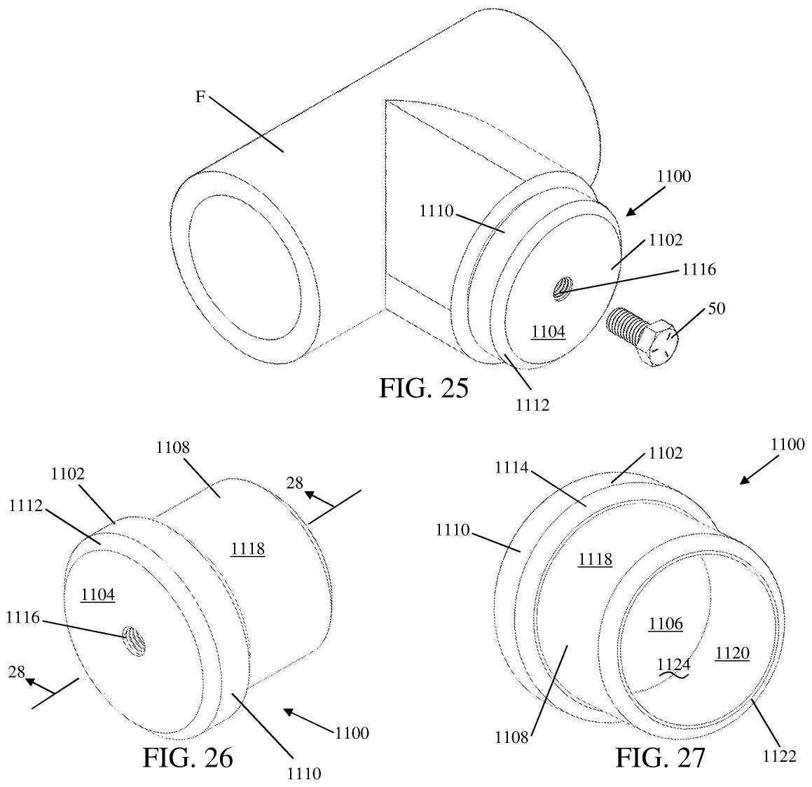

Referring to FIGS. 25-28, an eleventh embodiment of an attachment device for coupling a non-structural component to a structural component, such as the sway brace/restraint 10, is generally indicated at reference numeral 1100. The attachment device 1100 is configured to be attached to the non-structural component, such as a pipe P, and to a structural component. The attachment device 1100 is configured to be attached to a fitting F that is attached to the non-structural component and is a part of the non-structural component system. Specifically, the attachment device 1100 is configured to be attached to the sections of the fitting that are typically used to receive a non-structural component (e.g., the opening in the fitting the non-structural component is inserted into). As mentioned above, fittings for non-structural components are known in the art and, thus, a detailed description is omitted here. In the illustrated embodiment, the fitting F is a tee fitting. In other embodiments, the fitting F may be a coupling fitting, cross fitting, elbow fitting or any other fitting used to connect two or more non-structural components together.

The attachment device 1100 includes a plug or cap 1102 (broadly, an attachment device member) having opposite top and bottom surfaces 1104 and 1106, respectively, and an annular wall 1108 extending from the bottom surface. The cap 1102 is disk-shaped and has an annular perimeter surface 1110 extending between the top and bottom surfaces 1104, 1106. In the illustrated embodiment, the cap 1102 includes circumferential upper and lower shoulders 1112 and 1114, respectively, the upper shoulder extending between the upper surface 1104 and the perimeter surface 1110 and the lower shoulder extending between the annular wall 1108 and the perimeter surface. As shown in FIG. 25, the lower shoulder 1114 is configured to engage the edge of the fitting defining the opening the attachment device 1100 is inserted into. The cap 1102 defines a threaded opening 1116 (broadly, an attachment component for attaching the attachment device to the structural component) configured to receive a fastener 50 (e.g., bolt) to attach the attachment device 1100 to a structural component. The threaded opening 1116 extends into the cap 1102 from the top surface 1104 and has a base that is spaced apart from the bottom surface 1106 (e.g., the threaded opening does not extend through the cap). The illustrated threaded opening 1116 is positioned at the center of the cap 1102. The cap 1102 may also include a non-threaded attachment feature for attaching the attachment device 1100 to a structural component.

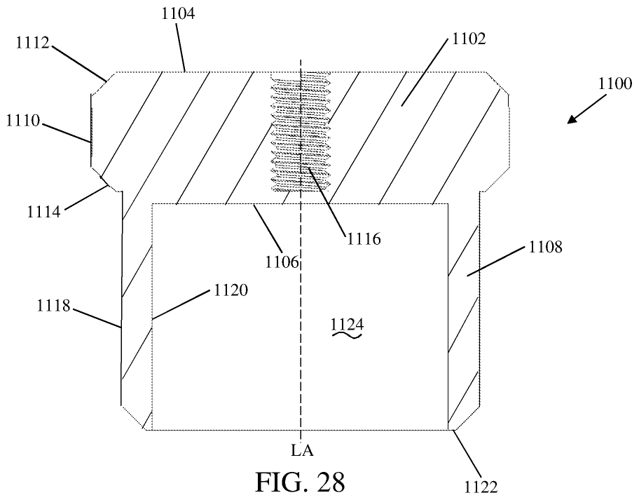

As shown in FIG. 28, the cap 1102 and annular wall 1108 define a longitudinal axis LA extending through the attachment device 1100 (e.g., the centers of the cap and annular wall are aligned). The annular wall 1108 extends from the cap 1102 at a position that is radially inward (e.g., toward the longitudinal axis LA) from the perimeter surface 1110. The annular wall 1108 extends from the cap 1102 to a free end 1122. The annular wall 1108 has an exterior surface 1118 (broadly, a fastening component) and an interior surface 1120. The free end 1122 of the annular wall is tapered radially inward from the exterior surface 1118 to facilitate the positioning of the attachment device 1100 in the fitting F. The interior surface 1120 of the annular wall 1108 and the bottom surface 1106 of the cap 1102 define a void 1124. The annular wall 1108 is configured to be inserted into and secured to the fitting F (specifically, a non-structural attachment opening defined by the fitting and configured to receive an end of a non-structural component). The exterior surface 1118 is configured to engage the fitting F to secure the attachment device 1100 therein. The annular wall 1108 has a radius (from the longitudinal axis LA to the exterior surface 1118) that is dimensioned to correspond to a radius of the opening in the fitting F the annular wall is inserted into. The attachment device 1100 and, more specifically, the annular wall 1008, can be secured to the fitting F in a number of different ways. For example, in one embodiment, the radius of the annular wall 1108 matches or is slightly larger than the fitting radius so that the annular wall forms a press-fit connection with the fitting F. In another embodiment, the exterior surface 1118 of the annular wall includes threads (not shown) that correspond to threads of the fitting F so that the attachment device 1100 may be threaded into the fitting. Still further, in one embodiment, the exterior surface 1118 is coated with adhesive (broadly, a fastening component) which bonds to the fitting F when the attachment device 1100 is inserted therein. Other ways of attaching the attachment device 1100 to the fitting are within the scope of the present disclosure. Moreover, any of these ways to connect the attachment device 1100 to the fitting F can form a fluid-tight or leak-proof seal between the attachment device and fitting so that any fluid (for example, water that is carried in pipes the fitting is attached to) that passes through the fitting does not escape. The annular wall 1008 has a height (from the bottom surface 1106 to the free end 1122) that is dimensioned to provide the exterior surface 1118 of the annular wall with a sufficiently amount of surface area so that the exterior surface can be secured to the fitting F.

As described above, the attachment device 1100 is connected to the fitting F and to a structural component. When the attachment device 1100 is connected to the fitting F and the structural component, the non-structural component (e.g., pipes but which can also include the fitting) is prevented from moving with respect to the attachment device. Thus, the attachment device 1100 is configured to be attached to the non-structural component in a manner that does not compress (e.g., deform) the non-structural component while inhibiting movement of the non-structural component (relative to the attachment device).

The attachment device 1100 can be formed from a single piece of material, such as metal (e.g., steel, copper), plastic (e.g., thermoplastic, polyvinyl chloride, chlorinated polyvinyl chloride), or any other suitable material.

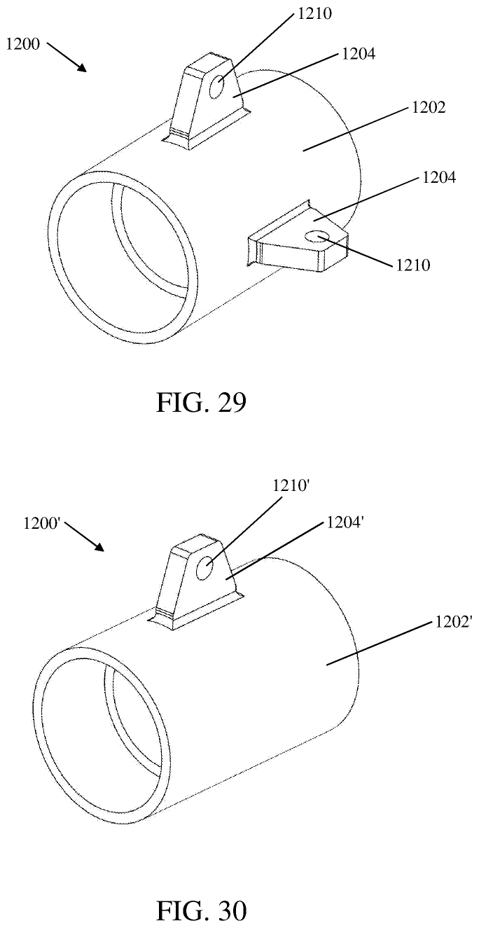

Referring to FIGS. 29 and 30, a twelfth embodiment of an attachment device for coupling a non-structural component to a structural component, such as the sway brace/restraint 10, is generally indicated at reference numeral 1200. The attachment device 1200 is configured to be attached to the non-structural component, such as a pipe P, and to a structural component. The attachment device 1200 includes a body portion 1202 (broadly, an attachment device member) that is a fitting configured to receive and connect to non-structural components, as generally known in the art and described above. In the illustrated embodiment, the body portion 1202 is a coupling fitting. In other embodiments, the body portion 1202 may be a tee fitting, cross fitting, cap fitting, elbow fitting or any other fitting used with the non-structural component. As mentioned above, fittings that connect to non-structural components, such as pipes, are known in the art and, thus, a detailed description is omitted here. However, as shown in FIGS. 29 and 30, the attachment device 1200 includes one or more connection tabs 1204 (broadly, at least one connection tab) fixed to the coupling fitting (e.g., body portion 1202). The one or more connection tabs 1204 are configured to be attached to the structural component. Each connection tab 1204 extends radially outward from the exterior surface of the body portion 1202. In the illustrated embodiment, the connection tabs 1204 extend outward from the body portion 1202 near the longitudinal midpoint of the body portion (e.g., halfway between opposite ends of the body portion). In other embodiments the connection tabs 1204 may be at other longitudinal positions along the body portion 1202. The illustrated attachment device 1200 includes two connection tabs 1204 that are unevenly spaced, circumferentially, around the body portion 1202 (e.g., the two connection tabs 1204 are approximately 90 degrees apart from one another). In other embodiments, the connection tabs 1204 can be evenly spaced, circumferentially, around the body portion 1202. Thus, the one or more connection tabs 1204 can be positioned anywhere on the body portion 1202. Each connection tab 1204 is connected to the body portion 1202 at one end (e.g., base) and defines a fastener opening 1210. The illustrated connection tabs 1204 have a generally triangular shape. The free end of the connection tab 1204 is spaced from the body portion 1202 such that the fastener opening 1210 is positioned away from the body portion. A fastener (not shown), such as a bolt, can be inserted through the fastener opening 1210 in each connection tab 1204 to attach the attachment device 1200 to a structural component. The connection tab 1204 is, broadly, an attachment component for attaching the attachment device to the structural component. Each connection tab 1204 may be integrally formed with the body portion 1202. It is understood the one or more connection tabs 1204 can have other arrangements than described herein. For example, the connection tabs can be separately formed and attached to the body portion 1202 in a suitable manner.

When the attachment device 1200 is connected to the non-structural component and the structural component, the non-structural component is prevented from moving with respect to the attachment device. Because the attachment device 1200 is part of the non-structural component system (e.g. a fitting), the structural component is able to be coupled to the non-structural component via the attachment device without applying forces which may damage or deform the non-structural component. Thus, the attachment device 1200 is configured to be attached to the non-structural component in a manner that does not compress (e.g., deform) the non-structural component while inhibiting movement of the non-structural component (relative to the attachment device).

The attachment device 1200 can be made from metal (e.g., steel, copper), plastic (e.g., thermoplastic, polyvinyl chloride, chlorinated polyvinyl chloride), or any other material fittings used with the non-structural component are made of. In the illustrated embodiment, the attachment device 1200 is formed from a single piece of material, such as plastic that has been injection molded into shape.

As shown in FIG. 29, the attachment device 1200 includes two connector tabs 1204. In other embodiments, the attachment device 1200 includes more or less connector tabs 1204. One example of such an attachment device is generally indicated at 1200′ in FIG. 30. The attachment device 1200′ is substantially the same as attachment device 1200 except that the attachment device 1200′ only includes one connector tab 1204′. The connector tab 1204′ is identical to the connector tabs 1204.

It is appreciated that the various attachment devices described above can be sized and shaped to attach to non-structural components of any size. For example, the various attachment devices describe above can be sized to attach to a pipe P that is 3 inches (7.6 cm) in diameter or 1 inch (2.5 cm) in diameter. It is also appreciated that the various attachment devices can have other shapes than described above and illustrated in order to attach to non-structural components having other cross-sectional shapes such as, but not limited to, a square cross-sectional shape. Moreover, the various attachment devices described above can be used in any situation, including seismic bracing of non-structural components.

It is apparent that the elements, features, and/or teachings set forth in each embodiment disclosed herein are not limited to the specific embodiments the elements, features and/or teachings are described in. Accordingly, it is understood that the elements features and/or teachings described in one embodiment may be applied to one or more of the other embodiments disclosed herein. For example, it is understood that any and all teachings regarding an adhesive of an attachment device in one embodiment may be applied to any of the other embodiments of the attachment devices.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

### Other Statements of the Invention

The following are statements of invention described in the present application. Although some of the following statements are not currently presented as claims, the statements are believed to be patentable and may subsequently be presented as claims. Associated methods, such as methods corresponding to statements of apparatus or systems below, are also believed to be patentable and may subsequently be presented as claims. It is understood that the following statement may refer to one, more than one or all of the embodiments described above and be supported by one, more than one or all of the embodiments described above.

A1. An attachment device for securing a non-structural component of a building to a structural component of the building, the attachment device comprising a body configured for attachment to the non-structural component, and an attachment component on the body for attaching the body to the structural component, the attachment of the body to the non-structural component providing an attachment force that does not compress the non-structural component and inhibits movement of the non-structural component relative to the attachment device.

B1. An attachment device for securing a non-structural component to a structural component of a building, the attachment device comprising a body configured for attachment to the non-structural component, fastening components one of on the body and attachable to the body for attaching the body to the non-structural component, the fastening components engaging the body at first locations on the body, and an attachment component on the body for attaching the structural component to the body at a second location on the body spaced away from the first locations for securing the structural component to the non-structural component, the attachment of the body to the non-structural component providing an attachment force that does not compress the non-structural component and inhibits movement of the non-structural component relative to the attachment device.

B2. The attachment device of claim B1, wherein the fastening components comprise bolts.

B3. The attachment device of claim B1, wherein the fastening components comprise adhesive.

B4. The attachment device of claim B1, wherein the fastening components comprise a surface of the body.

B5. The attachment device of claim B1, further comprising a compressive material configured to be disposed between the body and the non-structural component such that the body compresses the compressive material when the attachment device is attached to the non-structural component.

B6. The attachment device of claim B1, further comprising a plurality of attachment components.

B7. The attachment device of claim B1, wherein the attachment component is formed from the body.

B8. The attachment device of claim B1, wherein the attachment component extends laterally from the body.

B9. The attachment device of claim B1, in combination with a brace or restraint for attaching the attachment device to the structural component of the building.

B10. The attachment device of claim B9, wherein the attachment device in combination with the brace or restraint comprises a longitudinal sway brace or restraint assembly.

B11. The attachment device of claim B1, wherein the attachment device is a seismic attachment device configured for seismic bracing or restraining of the non-structural component.

C1. A method of securing a non-structural component to a structural component in a building, the method comprising:

attaching an attachment device to the non-structural component with fastening components one of on the body and attachable to the body, the fastening components engaging the body at first locations on the body;

attaching a structural component to an attachment component on the body at a second location on the body spaced away from the first locations; and

providing a non-compressive attachment force when attaching the body to the non-structural component such that the attachment device does not compress the non-structural component and inhibits movement of the non-structural component relative to the attachment device.

C2. The method of claim C1, wherein the non-structural component is formed from a material that cannot withstand compressive loads typically applied by conventional attachment devices.

C3. The method of claim C1, wherein the attachment device is a seismic attachment device configured for seismic bracing or retraining of the non-structural component.

D1. An attachment device for securing a non-structural component of a building to a structural component of the building, the attachment device comprising:

an attachment device member configured to be attached to the non-structural component and to partially surround the non-structural component;

a fastening component configured to form a connection between the non-structural component and the attachment device member, wherein the connection does not compress the non-structural component and inhibits movement of the non-structural component relative to the attachment device member; and

an attachment component coupled to the attachment device member and configured to attach to the structural component for securing the non-structural component to the structural component via the attachment device member.

D2. The attachment device of claim D1, wherein the fastening component is adhesive.

D3. The attachment device of claim D2, wherein the attachment device member is arcuate.

D4. The attachment device of claim D3, wherein the attachment device member defines a receiving space sized and shaped to receive a portion of the non-structural component in order to attach the attachment device member to the non-structural component.

D5. The attachment device of claim D4, wherein the attachment device member includes an inner surface defining the receiving space.

D6. The attachment device of claim D5, wherein the adhesive is disposed on the inner surface of the attachment device member and is configured to engage the non-structural component when the non-structural component is inserted into the receiving space.

D7. The attachment device of claim D6, wherein the attachment device member is a partially cylindrical wall.

D8. The attachment device of claim D7, wherein the partially cylindrical wall is sized and shaped to circumferentially extend about halfway around the non-structural component.

D9. The attachment device of claim D1, wherein the attachment component projects outward from the attachment device member.

D10. The attachment device of claim D9, wherein the attachment component defines an opening spaced apart from the attachment device member and sized and shaped to receive a fastener to attach the attachment component to the structural component.

D11. The attachment device of claim D10, wherein the attachment component is a first attachment component and the opening is a first opening, wherein the attachment device further comprises a second attachment component projecting outward from the attachment device member, the second attachment component defining a second opening spaced apart from the attachment device member and sized and shaped to receive a fastener to attach the attachment component to the structural component.

D12. The attachment device of claim D11, wherein the first and second openings are aligned to receive a single fastener to connect the first and second attachment components to the structural component.

D13. The attachment device of claim D1, wherein the attachment device member and attachment component are one piece of material.

D14. The attachment device of claim D13, wherein the attachment device member and attachment component are formed from one piece of sheet metal.

D15. The attachment device of claim D1, wherein the connection between the non-structural component and the attachment device member inhibits longitudinal, lateral and rotational movement of the non-structural component relative to the attachment device member.

D16. The attachment device of claim D2, in combination with the non-structural component, wherein the attachment device member is connected to the non-structural component via the adhesive.

E1. An attachment device for securing a non-structural component of a building to a structural component of the building, the attachment device comprising:

first and second attachment device members configured to be coupled to one another to attach the first and second attachment device members to the non-structural component, the first and second attachment device members being sized and shaped to surround the non-structural component, the first and second attachment device members configured to not deform the non-structural component and inhibit the movement of the non-structural component relative to the first and second attachment device members when the first and second attachment device members are attached to the non-structural component;

at least one fastening component configured to couple the first and second attachment device members together; and

at least one attachment component attached to at least one of the first and second attachment device members and configured to attach to the structural component for securing the non-structural component to the structural component via the first and second attachment device members.

E2. The attachment device of claim E1, wherein the first and second attachment device members define a receiving space sized and shaped to receive the non-structural component to attach the first and second attachment device members to the non-structural component when the first and second attachment device members are coupled together.

E3. The attachment device of claim E1, wherein each of the first and second attachment device members are sized and shaped to extend about halfway around the non-structural component.

E4. The attachment device of claim E1, wherein the first attachment device member is sized and shaped to extend about three-quarters of the way around the non-structural component and the second attachment device member is sized and shaped to extend about one-quarter of the way around the non-structural component.

E5. The attachment device of claim E4, wherein the first attachment device member defines a portion of a receiving space sized and shaped to receive the non-structural component and a mouth in communication with the portion of the receiving space, the first attachment device member being resiliently deflectable to enlarge the mouth to permit the non-structural component to be inserted through the mouth and into the portion of the receiving space.

E6. The attachment device of claim E1, wherein the at least one fastening component includes two fastening components.

E7. The attachment device of claim E6, wherein one of the at least one fastening components is a fastener.

E8. The attachment device of claim E6, wherein one of the at least one fastening components comprises first and second interlocking portions that are part of the first and second attachment device members, respectively, and are configured to interlock with one another to connect the first and second attachment device members.

E9. The attachment device of claim E9, wherein the first and second interlocking portion form a hinge about which the first and second attachment device members can rotate.

E10. The attachment device of claim E1, wherein each of the first and second attachment device members includes a connection flange, the connection flange of the first attachment device member being configured to be attached to the connection flange of the second attachment device member by the least one fastening component to couple the first and second attachment device members together.

E11. The attachment device of claim E10, wherein the connection flanges are the at least one attachment component.

E12. The attachment device of claim E1, wherein each of the first and second attachment device members includes first and second connection flanges, the first connection flanges of the first and second attachment device members being configured to be attached to together by one of the least one fastening components and the second connection flanges of the first and second attachment device members being configured to be attached to together by another one of the least one fastening components to couple the first and second attachment device members together.

E13. The attachment device of claim E12, wherein at least one of the first connection flanges and second connection flanges are the at least one attachment component.

E14. The attachment device of claim E1, further comprising a compressible material configured to be disposed between the first and second attachment device members and the non-structural component such that the first and second attachment device members compress the compressible material when the first and second attachment device members are attached to the non-structural component.

E15. The attachment device of claim E2, wherein each of the first and second attachment device members includes an arcuate portion, the arcuate portions defining the receiving space.

E16. The attachment device of claim E15, wherein the arcuate portions are each a partially cylindrical wall.

E17. The attachment device of claim E1, wherein the at least one attachment component projects outward from one of the first and second attachment device members.

E18. The attachment device of claim E17, wherein the at least one attachment component defines an opening sized and shaped to receive a fastener to attach the attachment component to the structural component.

E19. The attachment device of claim E18, wherein the at least one attachment component is a first attachment component and the opening is a first opening, wherein the attachment device further comprises a second attachment component of the at least one attachment component, the second attachment component defining a second opening sized and shaped to receive a fastener to attach the attachment component to the structural component.

E20. The attachment device of claim E19, wherein the first and second openings are aligned to receive a single fastener to connect the first and second attachment components to the structural component.

E21. The attachment device of claim E1, wherein the first and second attachment device members are configured to not compress the non-structural component when the first and second attachment device members are attached to the non-structural component.

E22. The attachment device of claim E1, wherein the connection between the non-structural component and the attachment device member inhibits at least one of longitudinal, lateral and rotational movement of the non-structural component relative to the attachment device member.

E23. The attachment device of claim E1, further comprising a sleeve configured to be disposed between the first and second attachment device members and the non-structural component, the sleeve defining a receiving space sized and shaped to receive the non-structural component.

E24. The attachment device of claim E23, wherein the sleeve is generally rigid.

E25. The attachment device of claim E23, wherein the sleeve includes two sleeve members.

E26. The attachment device of claim E23, wherein the sleeve defines one or more recesses and one of the first and second attachment device members includes one or more projections, each recesses configured to receive one of the projections to inhibit the sleeve from moving relative to said one of the first and second attachment device members when the sleeve is disposed between the non-structural component and said one of the first and second attachment device members.

E27. The attachment device of claim E1, further comprising an adhesive on at least one of the first and second attachment device members, the adhesive configured to engage the non-structural component to secure said at least one of the first and second attachment device members to the non-structural component.

E28. The attachment device of claim E27, in combination with the non-structural component, wherein said at least one of the first and second attachment device members is connected to the non-structural component via the adhesive.

F1. An attachment assembly for securing at least two non-structural components of a non-structural component system of a building to a structural component of the building; the attachment assembly comprising:

a fitting configured to be coupled to the at least two non-structural components of the building to interconnect the at least two non-structural components, the fitting forming a portion of the non-structural component system; and

at least one attachment component attached to the fitting and configured to attach to the structural component for securing the fitting to the structural component.

F2. The attachment assembly of claim F1, wherein the at least one attachment component includes two attachment components.

F3. The attachment assembly of claim F2, wherein the two attachment components are circumferentially spaced apart from one another on the fitting.

F4. The attachment assembly of claim F1, wherein the at least one attachment component projects outward from the fitting.

F5. The attachment device of claim F4, wherein each at least one attachment component defines an opening spaced apart from the fitting and sized and shaped to receive a fastener to attach the attachment component to the structural component.

G1. An attachment assembly for securing at least one non-structural component of a non-structural component system of a building to a structural component of the building; the attachment assembly comprising:

a fitting defining at least two non-structural attachment openings, each non-structural attachment opening being configured to couple to one of the at least one non-structural components of the building, the fitting forming a portion of the non-structural component system; and

an attachment device member configured to be inserted into one of the at least two non-structural attachment openings, the attachment device member configured to attach to the structural component for securing the fitting to the structural component.

G2. The attachment assembly of claim G1, wherein the attachment device member is a plug configured to be secured within said one of the at least two non-structural attachment openings.

G3. The attachment assembly of claim G2, wherein the plug is secured to the fitting by one of a press-fit connection, a threaded connection, and an adhesive.

G4. The attachment assembly of claim G1, wherein the attachment device member includes an attachment component configured to facilitate attachment of the attachment device member to the structural component.

G5. The attachment assembly of claim G4, wherein the attachment component is an opening sized and shaped to receive a fastener to attach the attachment device member to the structural component.

G6. The attachment assembly of claim G5, wherein the opening is threaded.

G7. The attachment assembly of claim G2, wherein the plug closes and forms a leak proof seal with said one of the at least two non-structural attachment openings.

H1. An attachment assembly for securing at least one non-structural component of a non-structural component system of a building to a structural component of the building; the attachment assembly comprising:

a cross fitting configured to be coupled to up to four non-structural components of the building to interconnect the non-structural components, the fitting forming a portion of the non-structural component system, the cross fitting including four corners, each corner defined by and disposed between adjacent attachment portions of the cross fitting, each attachment portion configured to couple to one of the non-structural components, a crosswise distance between opposite corners being less than a longitudinal distance between outward ends of opposite attachment portions; and

an attachment device member configured to attach to the structural component for securing the cross fitting to the structural component to inhibit movement of the cross fitting relative to the attachment device member, the attachment device member defining a receiving space configured to receive the cross fitting, the attachment device member sized and shaped to extend over the cross fitting in a crosswise direction to secure the cross fitting to the structural component without compressing the non-structural component when the cross fitting is received in the receiving space, the receiving space having a width greater than the crosswise distance and less than the longitudinal distance.

H2. The attachment assembly of claim H1, wherein the attachment device member includes opposing portions defining the width, the opposing portions configured to be disposed next to respective opposite corners of the cross fitting when the attachment device member secures the cross fitting to the structural component.

H3. The attachment assembly of claim H2, wherein the engagement between each portion of the attachment device member and the adjacent attachment portions of the cross fitting defining the corner said portion of the attachment device member is disposed next to inhibits the cross fitting from moving laterally and longitudinally relative to the structural component when the attachment device member secures the cross fitting to the structural component.

H4. The attachment assembly of claim H1, wherein the attachment device member includes first and second attachment components configured to facilitate attachment of the attachment device member to the structural component.

H5. The attachment assembly of claim H4, wherein each attachment component includes a connection tab defining an opening sized and shaped to receive a fastener to attach the attachment device member to the structural component.

I1. An attachment assembly for securing at least one non-structural component of a non-structural component system of a building to a structural component of the building; the attachment assembly comprising:

a fitting configured to be coupled to the at least two non-structural components of the building to interconnect the at least two non-structural components, the fitting forming a portion of the non-structural component system, the fitting defining a groove extending circumferentially around the fitting; and

an attachment component configured to be received in the groove to attach the attachment component to the fitting, the attachment component configured to attach to the structural component for securing the fitting to the structural component, the attachment component configured to not compress the fitting and to inhibit movement of the fitting relative to the structural component when the attachment component secures the fitting to the structural component.

I2. The attachment assembly of claim I1, wherein the attachment component defines a receiving space configured to receive the fitting when the attachment component is attached to the fitting.

I3. The attachment assembly of claim I2, wherein the receiving space has a diameter that is larger than a diameter of a base of the groove and less than the dimeter of an exterior surface of the fitting, the groove extending inward from the exterior surface.

I4. The attachment assembly of claim I3, wherein engagement between the attachment component and walls of the fitting defining the groove inhibit the fitting from moving laterally and longitudinally relative to the structural component when the attachment device member is secured in the groove and secures the fitting to the structural component.

I5. The attachment assembly of claim I1, wherein the attachment component includes a base and a connection tab overlying a portion of the base, the base and connection tab each defining an opening aligned with one another such that a fastener can be inserted there though to secure the base and connection tab together and to the structural component.

I6. The attachment assembly of claim I1, wherein at least a portion of the attachment component is resiliently deflectable to permit the base and connection tab to move away from one another to allow the attachment component to be inserted into the groove.

J1. An attachment device for securing a non-structural component assembly of a building to a structural component of the building, the non-structural component assembly including at least first and second non-structural components connected together with a fitting, the attachment device comprising:

a first pair of first and second attachment members configured to be coupled to one another to attach the first pair of first and second attachment members to the first non-structural components at a first location along the non-structural component assembly, the first pair of first and second attachment members being sized and shaped to surround the first non-structural component when the first and second attachment members are connected together; the first pair of first and second attachment members configured to not compress the first non-structural component when the first and second attachment members are attached to the first non-structural component;

a second pair of third and fourth attachment members configured to be coupled to one another to attach the second pair of third and fourth attachment members to the second non-structural components at a second location spaced apart from the first location along the non-structural component assembly, the second pair of third and fourth attachment members being sized and shaped to surround said other non-structural component when the third and fourth attachment members are connected together, the second pair of third and fourth attachment members configured to not compress the second non-structural component when the third and fourth attachment members are attached to the second non-structural component; and

at least one attachment component attached to at least one of the attachment members and configured to attach to the structural component for securing the non-structural component assembly to the structural component via the attachment members;

wherein the first location is adjacent to a first end of the fitting and the second location is adjacent to a second end of the fitting, the first and second pairs configured to engage respective first and second ends of the fitting to inhibit movement of the non-structural component assembly relative to the attachment members when the attachment members are attached to the non-structural component assembly.

J2. The attachment device of claim J1, wherein the first and second members of the first pair are separate components and the third and fourth members of the second pair are separate components.

J3. The attachment device of claim J2, wherein the first and third attachment members are a part of a one-piece component.

J4. The attachment device of claim J1, further comprising at least one fastening component configured to couple the first and second attachment members together.

J5. The attachment device of claim J4, wherein one of the at least one fastening components is a fastener.

J6. The attachment device of claim J4, wherein one of the at least one fastening components includes first and second interlocking portions that are a part of the first and second attachment members, respectively, configured to interlock with one another to connect the first and second attachment members.

J7. The attachment device of claim J6, wherein the first and second interlocking portions form a hinge about which the first and second attachment members can rotate.

J8. The attachment device of claim J4, wherein the at least one fastening component includes a second fastening component configured to couple the third and fourth attachment members together.

J9. The attachment device of claim J8, wherein the second fastening component is a fastener.

J10. The attachment device of claim J4, wherein the second fastening component includes first and second interlocking portions that are a part of the third and fourth attachment members, respectively, configured to interlock with one another to connect the third and fourth attachment members.

J11. The attachment device of claim J10, wherein the first and second interlocking portions form a hinge about which the first and second attachment members can rotate.

J12. The attachment device of claim J1, wherein the first and third attachment members are identical.

J13. The attachment device of claim J1, wherein the second and fourth attachment members are identical.

J14. The attachment device of claim J1, wherein the engagement of the first and second pairs with respective first and second ends of the fitting inhibit longitudinal movement of the non-structural component assembly relative to the attachment members when the attachment members are attached to the non-structural component assembly.

J15. The attachment device of claim J1, wherein the first pair of first and second attachment members define a first receiving space sized and shaped to receive the first non-structural component and the second pair of third and fourth attachment members define a second receiving space sized and shaped to receive the second non-structural component.

J16. The attachment device of claim J15, wherein the first and second attachment members can pivot relative to one another and the third and fourth attachment members can pivot relative to one another to permit the first and second non-structural components to be interested into the respective first and second receiving spaces.

J17. The attachment device of claim J1, wherein the at least one attachment component defines an opening sized and shaped to receive a fastener to attach the at least one attachment component to the structural component.

J18. The attachment device of claim J17, wherein the at least one attachment component connects the first and third attachment members together.

J19. The attachment device of claim J17, wherein the at least one attachment component includes first and second attachment components, the first attachment component attached to one of the first and second attachment members and the second attachment component attached to one of the third and fourth attachment members.

J20. The attachment device of claim J19, wherein the openings in the first and second attachment components are configured to aligned so that a single fastener can extend there through to connect the first and second pairs together and to the structural component.

J21. The attachment device of claim J1, wherein a distance between the first pair of first and second attachment members and the second pair of third and fourth attachment members is adjustable.

J22. The attachment device of claim J1, in combination with the fitting.

What is claimed is:

1. An attachment device for securing a non-structural component of a building to a structural component of the building, the attachment device comprising:
an attachment device member configured to be attached to the non-structural component and to partially surround the non-structural component;
a fastening component configured to form a connection between the non-structural component and the attachment device member, wherein the connection does not compress the non-structural component and inhibits movement of the non-structural component relative to the attachment device member; and
an attachment component coupled to the attachment device member and configured to attach to the structural component for securing the non-structural component to the structural component via the attachment device member.

2. The attachment device of claim 1, wherein the fastening component is adhesive.

3. The attachment device of claim 2, wherein the attachment device member defines a receiving space sized and shaped to receive a portion of the non-structural component in order to attach the attachment device member to the non-structural component.

4. The attachment device of claim 3, wherein the attachment device member includes an inner surface defining the receiving space and wherein the adhesive is disposed on the inner surface of the attachment device member and is configured to engage the non-structural component when the non-structural component is inserted into the receiving space.

5. The attachment device of claim 4, wherein the attachment device member is a partially cylindrical wall.

6. The attachment device of claim 1, wherein the attachment component projects outward from the attachment device member, the attachment component defining an opening spaced apart from the attachment device member and sized and shaped to receive a fastener to attach the attachment component to the structural component.

7. The attachment device of claim 2, in combination with the non-structural component, wherein the attachment device member is connected to the non-structural component via the adhesive.

8. An attachment device for securing a non-structural component of a building to a structural component of the building, the attachment device comprising:
first and second attachment device members configured to be coupled to one another to attach the first and second attachment device members to the non-structural component, the first and second attachment device members being sized and shaped to completely surround the non-structural component, the first and second attachment device members configured to not deform the non-structural component and inhibit the movement of the non-structural component relative to the first and second attachment device members when the first and second attachment device members are attached to the non-structural component;
at least one fastening component configured to couple the first and second attachment device members together; and
at least one attachment component attached to at least one of the first and second attachment device members and configured to attach to the structural component for securing the non-structural component to the structural component via the first and second attachment device members.

9. The attachment device of claim 8, wherein the first and second attachment device members define a receiving space sized and shaped to receive the non-structural component to attach the first and second attachment device members to the non-structural component when the first and second attachment device members are coupled together.

10. The attachment device of claim 8, wherein each of the first and second attachment device members are sized and shaped to extend about halfway around the non-structural component.

11. The attachment device of claim 8, wherein the first attachment device member is sized and shaped to extend about three-quarters of the way around the non-structural component and the second attachment device member is sized and shaped to extend about one-quarter of the way around the non-structural component.

12. The attachment device of claim 11, wherein the first attachment device member defines a portion of a receiving space sized and shaped to receive the non-structural component and a mouth in communication with the portion of the receiving space, the first attachment device member being resiliently deflectable to enlarge the mouth to permit the non-structural component to be inserted through the mouth and into the portion of the receiving space.

13. The attachment device of claim 8, wherein the at least one fastening component includes two fastening components.

14. The attachment device of claim 13, wherein one of the at least one fastening components is a fastener.

15. The attachment device of claim 13, wherein the two fastening components comprise first and second interlocking portions that are part of the first and second attachment device members, respectively, and are configured to interlock with one another to connect the first and second attachment device members.

16. The attachment device of claim 15, wherein the first and second interlocking portion form a hinge about which the first and second attachment device members can rotate.

17. The attachment device of claim 8, wherein each of the first and second attachment device members includes a connection flange, the connection flanges of the first and second attachment device members being configured to be attached to together by the least one fastening component to couple the first and second attachment device members together.

18. The attachment device of claim 17, wherein the connection flanges are the at least one attachment component.

19. The attachment device of claim 8, further comprising an adhesive on at least one of the first and second attachment device members, the adhesive configured to engage the non-structural component or a structure surrounding the non-structural component to secure said at least one of the first and second attachment device members to the non-structural component.

20. The attachment device of claim 19, in combination with the non-structural component, wherein said at least one of the first and second attachment device members is connected to the non-structural component via the adhesive.
